(19) United States
(12) Patent Application Publication
(10) Pub. No.: US 2016/0154444 A1
(43) Pub. Date: Jun. 2, 2016

(54) THERMAL MANAGEMENT METHOD AND ELECTRONIC SYSTEM WITH THERMAL MANAGEMENT MECHANISM

(71) Applicant: MEDIATEK INC., Hsin-Chu (TW)

(72) Inventors: Tsu-Ming Liu, Hsinchu City (TW); Tsui-Shan Chang, Tainan City (TW); Chi-Cheng Ju, Hsinchu City (TW); Chih-Ming Wang, Hsinchu County (TW)

(73) Assignee: Mediatek Inc., Hsin-Chu (TW)

(21) Appl. No.: 14/905,821

(22) PCT Filed: Jun. 12, 2015
(86) PCT No.: PCT/CN2015/081372

§ 371 Date: Jan. 17, 2016

Related U.S. Application Data
(60) Provisional application No. 62/011,189, filed on Jun. 12, 2014.

(51) Int. Cl. G06F 1/20; H04N 5/232; G05B 15/02

(52) U.S. Cl. CPC G06F 1/206; G05B 15/02; H04N 5/23216

(57) ABSTRACT

Disclosed is a thermal management method for controlling a temperature of an image/video processing module for an image capturing device or a video recording device. The thermal management method comprises: (a) acquiring at least one device parameter for at least one first device of the image/video processing module; and (b) adjusting at least one operating parameter for at least one second device of the image/video processing module according to the device parameter.

### CROSS REFERENCE TO RELATED APPLICATIONS

This application claims the benefit of U.S. Provisional Application No. 62/011,189, filed on Jun. 12, 2014, the contents of which are incorporated herein by reference.

### TECHNICAL FIELD

The present invention relates to a thermal management method and an electronic system with a thermal management mechanism, and particularly relates to a thermal management method which can control a temperature for at least one device of an image/video processing module, and an electronic system with such thermal management mechanism.

### BACKGROUND

The temperature for an electronic apparatus is highly regarded, since a high temperature may affect the performance of the electronic apparatus, or makes the user feel un-comfortable, or even burns the user.

Therefore, the temperature of the electronic apparatus should be carefully controlled. For example, following IEC 62368-1, Audio/Video, Information Technology and Communication Technology Equipment—Part 1: Safety Requirement, the touch temperature limit for touchable surfaces is 48° C.

However, if the temperature of the electronic apparatus is desired to be decreased, the whole performance of the electronic apparatus is always suppressed to decrease the temperature.

### SUMMARY

Therefore, one objective of the present invention is to provide a thermal management method can adjust only few devices of the electronic system to control the temperature.

Another objective of the present invention is to provide an electronic system that can adjust only few devices thereof to control the temperature.

One embodiment of the present application is to provide a thermal management method, for controlling a temperature of an image/video processing module for an image capturing device or a video recording device, comprising: (a) acquiring at least one device parameter for at least one first device of the image/video processing module; and (b) adjusting at least one operating parameter for at least one second device of the image/video processing module according to the device parameter.

Another embodiment of the present application is to provide an electronic system with a thermal control mechanism, comprising: an image/video processing module, configured to g record or capture image data or video data; a parameter acquiring device, configured to acquire at least one device parameter for at least one first device of the image/video processing module; and a thermal management device, configured to adjust at least one operating parameter for at least second device of the image/video processing module according to the device parameter.

In view of above-mentioned embodiments, the temperature can be controlled via adjusting only a few devices, thus the performance for whole electronic apparatus would not greatly decrease.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram illustrating an electronic system applying a thermal management method according to one embodiment of the present invention.

FIG. 2 is a block diagram illustrating detail structures for the parameter acquiring device depicted in FIG. 1, according to one embodiment of the present invention.

FIG. 3 is a block diagram illustrating detail structures for the thermal management device depicted in FIG. 1, according to one embodiment of the present invention.

FIG. 4 is a block diagram illustrating detail structures for the image/video processing module depicted in FIG. 1, according to one embodiment of the present invention.

FIG. 5 is a flow chart illustrating a thermal management method according to one embodiment of the present invention.

FIG. 6 is a schematic diagram illustrating a thermal management method according to one embodiment of the present invention.

FIG. 7-FIG. 26 are schematic diagrams illustrating operations for the thermal management method applied to the image/video processing module depicted in FIG. 4, according to different embodiments of the present invention.

FIG. 27 is a block diagram illustrating detail structures for the image/video processing module depicted in FIG. 1, according to another embodiment of the present invention.

FIG. 28-FIG. 50 are schematic diagrams illustrating operations for the thermal management method applied to the image/video processing module depicted in FIG. 27, according to different embodiments of the present invention.

### DETAILED DESCRIPTION

FIG. 1 is a block diagram illustrating an electronic system applying a thermal management method according to one embodiment of the present invention. As illustrated in FIG. 1, the electronic system 100 comprises an image/video processing module 101, a parameter acquiring device 103 and a thermal management device 105. The image/video processing module 101 is a module that can process a single image (e.g. a still image) or video data comprising a plurality of images (e.g. video stream). In some embodiments, the image/video processing module 101 may be part of a device for image capturing, video recording or any other image/video related function.

The parameter acquiring device 103 can acquire at least one device parameter DP corresponding to a first device in the image/video processing module 101. The thermal management device 105 adjusts at least one operating parameter DP for a second device of the image/video processing module 101 according to the device parameter DP. In one embodiment of this invention, the thermal management device 105 may perform such adjustment without adjusting any setting or configuration of a central processing unit (CPU) of the electronic system 100. In another embodiment of this invention, the thermal management device 105 may further perform such adjustment to the setting or configuration of the CPU of the electronic system 100. Please note the first device and the second device can be the same device, and can be different devices as well. For example, the first device and the second device are the same memory device. Alternatively, in another example, the first device is an image sensor, but the second device is a video encoder. Further, in still another example, a number of the first device or the second device is larger than 1, and the first device(s) and the second device(s) comprise at least one identical device.

The operation of processing the single image or the video data may comprises at least one of following operations: capturing the still image, encoding the still image, recording the video data, encoding the video data. The operation of processing the single image or the video data may further comprises the operations for processing captured still image or recorded video data. For example, store the captured still image or recorded video data to the memory device, or read the captured still image or recorded video data from the memory device. In another example, the operation of processing the single image or the video data may further comprises providing the captured still image or recorded video data for display. However, please note the terms “capturing” or “recording” are only examples for explaining the operations for the image/video processing module, thus the operations “capturing” or “recording” are not respectively fixed to image or video data. For example, the operations of processing the single image or the video data may comprises the operations of: recording the still image and capturing the video data.

The device parameter DP can be a consequence parameter representing or indicating its temperatures. In one embodiment, the device parameter DP comprises at least one of following parameters or the combination thereof: a temperature, a current value, power consumption, a signal delay value or any other kind of consequence parameter related to temperatures. In such example, directly according to the device parameter DP, the thermal management device 105 adjusts the operating parameter. In some embodiments, the relation between the temperature variation and the signal delay value may be utilized. For example, the signal delay for an inverter chain is dependent upon temperature. In detail, the signal delay for the inverter chain may increase as the temperature increases. Accordingly, the temperature may be determined based on a measured signal delay of an inverter chain of the first device.

Alternatively, the device parameter DP can be a configuration parameter related to the temperature. In one embodiment, the device parameter DP comprises at least one of following parameters or the combination thereof: a frame resolution, a frame rate, an ISO value, a focus level, an exposure level, a quantization parameter, a coding tool, a maximum motion search range, or any other kind of configuration parameter related to the temperature. In such example, the thermal management device 105 may acquire or receive temperature related information or the temperature via the device parameter DP. For example, the thermal management device 105 may acquire or receive temperature related information or the temperature via searching a pre-defined look up table based on the device parameter DP. In another example, the thermal management device 105 may compute or anticipate the device parameter DP to generate temperature related information or the temperature.

In one embodiment, the device parameter DP is generated by at least one operation performed by the first device. For example, the device parameter DP comprises at least one of following parameters or a combination thereof: a current required by the first device, and a temperature corresponding to the first device. Also, in another embodiment, the device parameter DP may include a configuration parameter of the first device. For example, the device parameter DP comprises at least one of following parameters or a combination thereof: a frame resolution, a frame rate, an ISO value, a focus level, an exposure level, a quantization parameter, or any other kind of configuration parameter related to the temperature.

Corresponding to different device parameters, the parameter acquiring device 103 may comprise different structures or configurations. For example, if the device parameter DP includes a temperature, the parameter acquiring device 103 may include a thermal sensor. Also, if the device parameter DP includes a frame rate, the parameter acquiring device 103 may include a device that can access the operating parameter for the device in the image/video processing module 101. For example, access configuration of the frame rate in a decoder in the image/video processing module 101.

The operating parameter to be adjusted may include an operating speed, any configuration parameter (such as a frame rate, an exposure value, a frame resolution, a brightness value, an operating voltage or any other configuration parameter), any parameter about operating the second device, or combination thereof.

Please note the device parameter DP and the operating parameter are not limited to above-mentioned examples. Further examples for the device parameter DP and the operating parameter will be explained later.

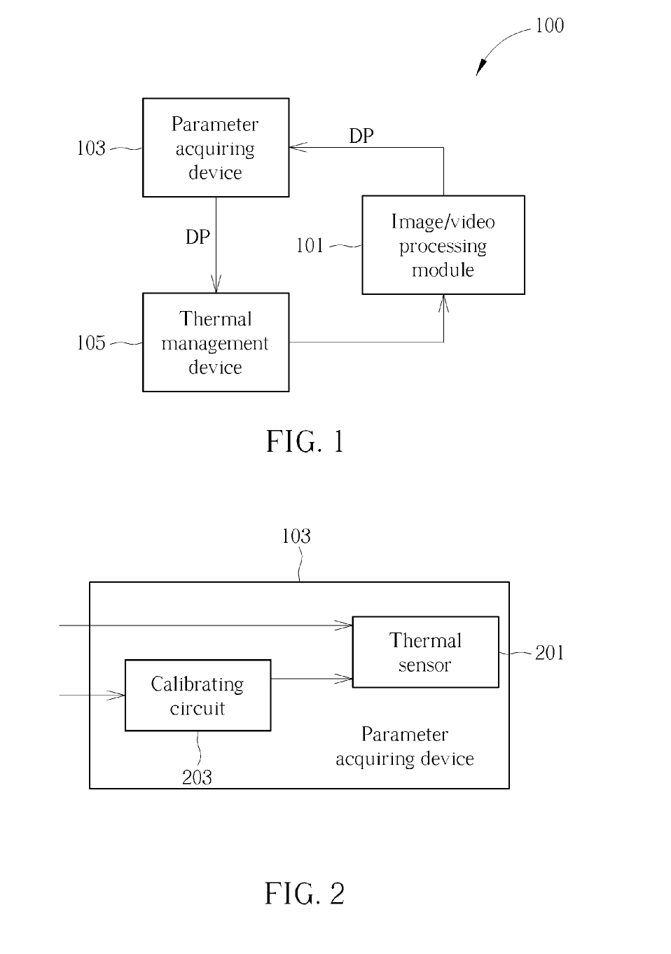

FIG. 2 is a block diagram illustrating detail structures for the parameter acquiring device 103 depicted in FIG. 1, according to one embodiment of the present invention. In this embodiment, the parameter acquiring device 103 may include a thermal sensing module, which can sense a parameter representing or indicating temperatures, for example, a temperature, a current value, a signal delay value. The parameter acquiring device 103 may include a thermal sensor 201, which directly senses the device parameter corresponding to the device in the image/video processing module. In some embodiments, the thermal sensor 201 may include an inverter chain which is temperature dependent. In one embodiment, the parameter acquiring device 103 further comprises a calibrating circuit 203, which is configured to minimize the measurement errors. The calibrating circuit 203 may be performed according to environmental temperature or information about the type of thermal sensor 201. In some embodiments, the calibration may be realized by table-look-up via off-line process. In some other embodiments, the calibration may be implemented via external thermometer or internal logic.

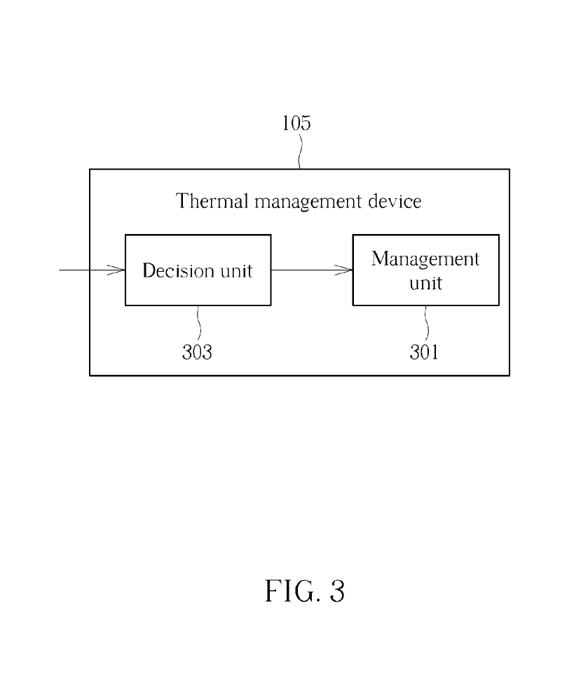

FIG. 3 is a block diagram illustrating detail structures for the thermal management device 105 depicted in FIG. 1, according to one embodiment of the present invention. In this embodiment, the thermal management device 105 comprises a management unit 301 and a decision unit 303. The decision unit 303 is configured to determine if the management unit 301 should be enabled or not according received parameters. For example, if the decision unit 303 receives a temperature, a current value or a value representing or indicating the temperature is higher than a corresponding threshold value, the decision unit 303 enables the management unit 301 to start thermal management.

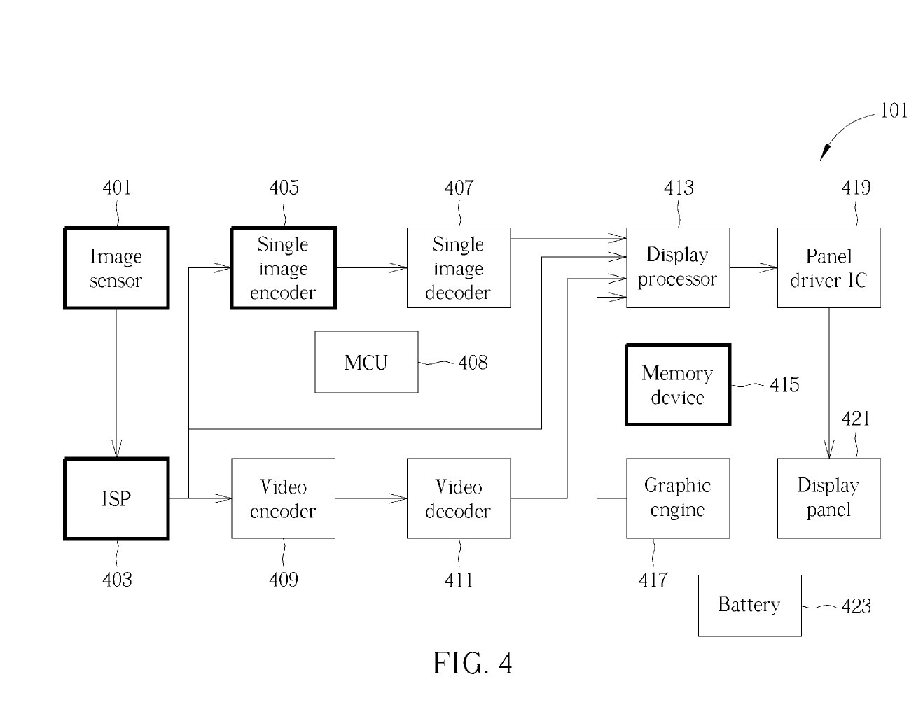

FIG. 4 is a block diagram illustrating detail structures for the image/video processing module depicted in FIG. 1, according to one embodiment of the present invention.

As shown in FIG. 4, the image/video processing module 101 may comprise at least one of an image sensor 401, an image signal processor 403, a single image encoder 405, a single image decoder 407, a micro control unit 408, a video encoder 409, a video decoder 411, a display processor 413, a memory device 415, a graphic engine 417, a panel driver IC 419, a display panel 421, a battery 423 or combination thereof. Please note, the image/video processing module 101 is not limited to comprising the devices depicted in FIG. 4. For example, if the image/video processing module 101 is implemented in a device that can capture or record image and display captured or recorded image, the image/video processing module 101 may comprise the display processor 413, the panel driver IC 419, the display 421 or combination thereof. In some embodiments, the display processor 413, the panel driver IC 419, and the display 421 may be not included in the image/video processing module 101, which should not be limited in this disclosure.

The image sensor 401 is configured to sense images (e.g. taking pictures). The image signal processor 403 is configured to process image signals from the image sensor 401. The single image encoder 405 and the single image decoder 407 are applied to process independent images (e.g. pictures) for image encoding and decoding respectively. Also, the micro control unit 408 is configured to control the operations for devices in the image/video processing module 101. The video encoder 409, the video decoder 411 are applied to process video data comprising a plurality of images (e.g. video stream) for video encoding and decoding respectively. The display processor 413 is configured to process images or video data from the single image decoder 407 the video decoder 411 or the graphic engine 417, to generate images or video data that can be displayed on the display panel 421. The memory device 415 (e.g. a DRAM) is configured to store images or video data, and the stored images or video data can be accessed and displayed on the display panel 421. The graphic engine 417 is configured to draw an image. The panel driver IC 419 is configured to drive the display panel 421.

Please note, if the image/video processing module 101 comprises the micro control unit 408, the above-mentioned operation of adjusting the operating parameter of the second device may comprise adjusting the operating frequency of the micro control unit 408, but not limited.

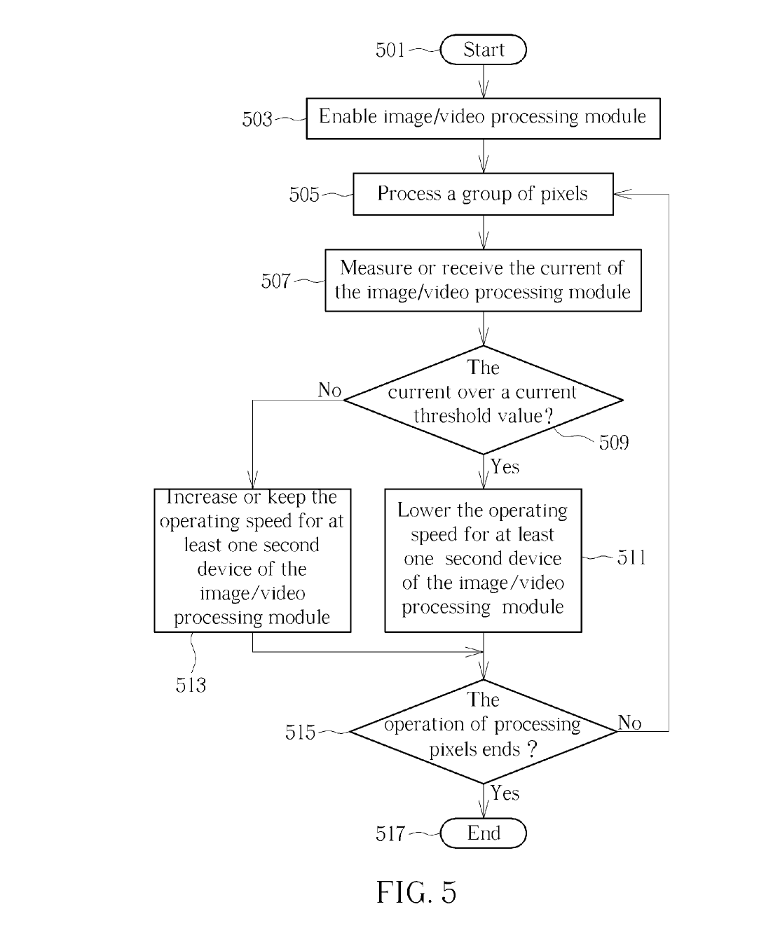

If the image/video processing module is applied to capture image data or configured for an image capturing device, the devices that tend to generate thermal may include: the image sensor 401, the image signal processor 403, the single image encoder 405, the memory device 415 or combination thereof. Therefore, these devices are applied as examples in the embodiments depicted in FIG. 5-FIG. 26. Please note these examples are only for explaining and do not mean to limit the scope of the present invention.

FIG. 5 is a flow chart illustrating a thermal management method according to one embodiment of the present invention. The flow chart in FIG. 5 comprises:

Step 501

Start

Step 503

Image/video processing module may be enabled.

Step 505

Process a group of pixels. The pixels can be received from the memory device 415, or from any other source inside or outside the image/video processing module 101.

Step 507

Measure or receive the current (i.e. the above-mentioned device parameter) for at least one first device of the image/video processing module 101. Please note, in some embodiments of step 507, the current for only one device of the image/video processing module 101 (e.g. the image sensor 401) may be measured or received, or a current amount for several devices of the image/video processing module 101 (e.g. the image signal processor 403 and the memory device 415) may be measured or received. In some embodiments of step 507, if the image/video processing module 101 is enabled for capturing image, the current value for the image sensor 401, the image signal processor 403, the single image encoder 405 and the memory device 415 or combination thereof may be measured or received. In other embodiments of step 507, if the image/video processing module 101 is enabled for recording video data, the current value for the image sensor 401, the image signal processor 403, the video encoder 409 and the memory device 415 or combination thereof may be measured or received. Furthermore, in some other embodiments of the step 507, the current value of the battery may be measured or received to represent the current value of the image/video processing module 101.

Step 509

Determine if the current measured or received in the step 507 is over a current threshold value or not. If yes, go to step 511, if not, go to step 513.

Step 511

Lower the operating speed (i.e. the above-mentioned operating parameter) for a second device of the image/video processing module 101. In one embodiment of step 511, the second device of the image/video processing module 101 may mean at least one of: the image signal processor 403, the single image encoder 405 and the memory device 415.

Step 513

Increase or keep the operating speed for a second device of the image/video processing module 101.

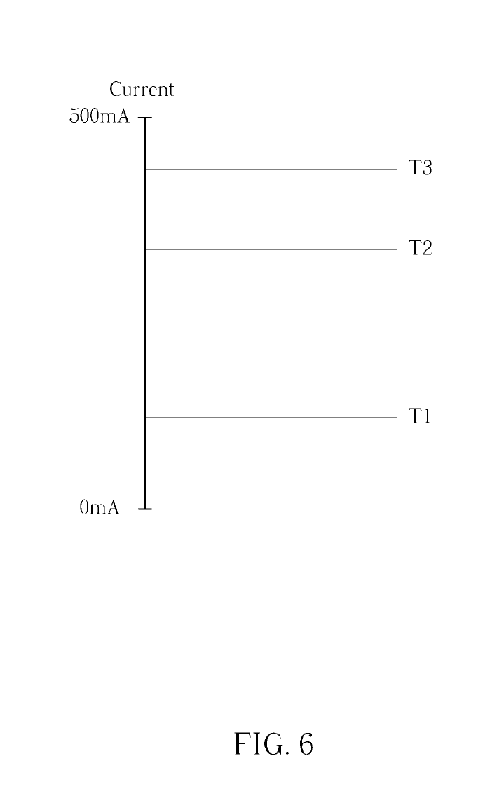

In one embodiment, several current threshold values can be provided, such as FIG. 6. In such embodiment, the step 511 is performed according to which range the current value measured or received in the step 507 locates in. For example, if the current is above the current threshold value T1 but below the current threshold value T2, the step 511 lowers the operating speed to a first level. Also, if the current value is above the current threshold value T2 but below the current threshold value T3, the step 511 lower the operating speed to a second level lower than the first level.

Step 515

If the operation of processing pixels ends may be determined. If yes, go to step 517, if not, go back to the step 505.

Step 517

End.

Since the current measured or received in the step 507 is a parameter representing or indicating the temperature, thus the step 507 can be regarded as an embodiment for “acquiring device parameter representing or indicating temperature”. In other embodiments, a temperature, a current value, or a signal delay value which is related to temperature variation, any other device parameter representing or indicating the temperature or combination thereof may be acquired.

In another embodiment, the step 507 is replaced with a step for “acquiring a device parameter, which may include temperate related information or a parameter for computing or anticipating temperature related information”. For example, acquire a frame resolution, a frame rate, an ISO value, a focus level, an exposure level, a quantization parameter, a coding tool, a maximum motion search range, or any other parameter related to the temperature. In such embodiment, the step 509 is correspondingly replaced by another step. For example, if the step 507 is replaced by a step of acquiring a frame resolution, the step 509 is replaced by a step of “determining if the frame resolution is over a resolution threshold value”. Please note, such step 507 can also be replaced with “acquiring a device parameter generated by at least one operation performed by the first device”, or be replaced with “acquiring a device parameter which is an operating parameter of the first device”.

For such embodiment, several resolution threshold values may be provided as well. As shown in following Table 1, several resolution threshold values are provided, and the operating speed may be adjusted to different values corresponding to which range the frame resolution located in. For example, but not limitation, when resolution is high, temperature may also go high. Therefore, when resolution is high, a low operating speed is set.

TABLE 1

| Resolution threshold | Adjustment |
|---|---|
| 1920 × 1080 | Operating speed level 1 |
| 4096 × 2160 | Operating speed level 2 |
| 7680 × 4320 | Operating speed level 3 |

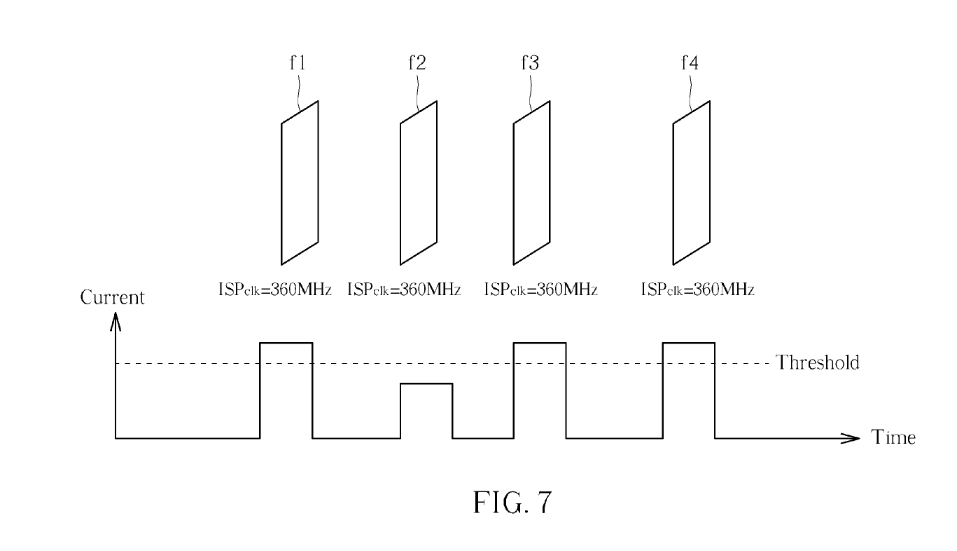

FIG. 7-FIG. 26 are schematic diagrams illustrating operations for the thermal management method applied to the image/video processing module depicted in FIG. 4, according to different embodiments of the present invention.

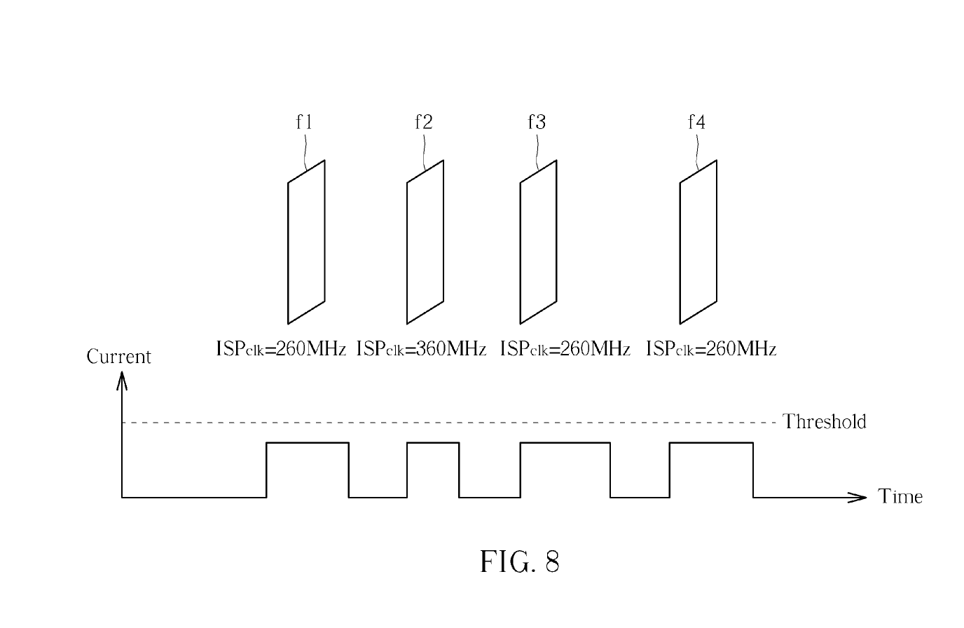

In the embodiments of FIG. 7 and FIG. 8, the device parameter includes a current value, and the operating parameter includes an operating speed. In one embodiment, the operating speed for at least one device of the image/video processing module is adjusted via adjusting a clock rate, but not limited. Further, in the embodiments of FIG. 7 and FIG. 8, the operating speed of the image signal processor 403 (ISP_{clk}) in FIG. 4 is adjusted. However, the combination of the current and the operating speed can be applied to any other device(s) (e.g. encoder) of the image/video processing module other than the image signal processor.

Please refer to FIG. 7, the clock rates for the timings that the image signal processor processes frames f1, f2, f3, f4 are all 360 MHz, and the current values for the timings that the image signal processor processes frames f1, f3, f4 are over a current threshold value. Accordingly, in the embodiment of FIG. 8, the clock rates for the timings that the image signal processor processes frames f1, f3, f4 are adjusted to 260 MHz. By this way, the current values for the timings that the image signal processor processes frames f1, f3, f4 may be lower than the current threshold value correspondingly.

Please note, in such embodiment, the image signal processor also operates at the clock rate 360 MHz at the timing for processing the frame f2. However, the current at the timing for processing the frame f2 is still lower than the current threshold value.

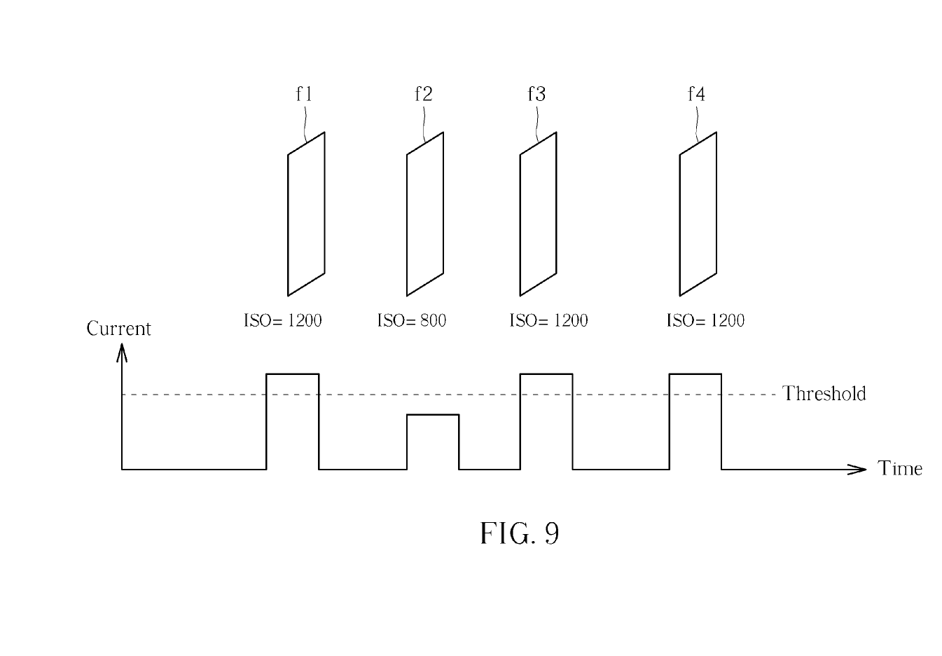

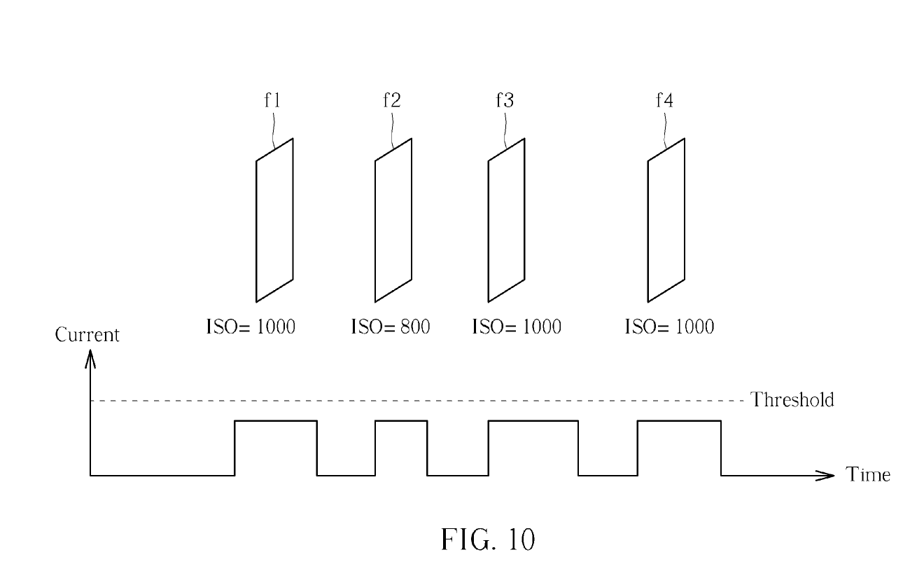

In the embodiments of FIG. 9 and FIG. 10, the device parameter includes a current value, and the operating parameter includes an ISO value. In the embodiments of FIG. 9 and FIG. 10, the ISO value of the image signal processor 403 in FIG. 4 is adjusted. However, the combination of the current and the ISO value can be applied to any other device(s) of the image/video processing module other than the image signal processor.

Please refer to FIG. 9, the ISO values for the timings that the image signal processor processes frames f1, f3, f4 are 1200, and the ISO value for the timing that the image signal processor processes the frame f2 is 800. For such case, the current values for the timings that the image signal processor processes frames f1, f3, f4 are over a current threshold value. Accordingly, in the embodiment of FIG. 10, the ISO values for the timings that the image signal processor processes frames f1, f3, f4 are adjusted to 1000. By this way, the current values for the timings that the image signal processor processes frames f1, f3, f4 may be lower than the current threshold value correspondingly.

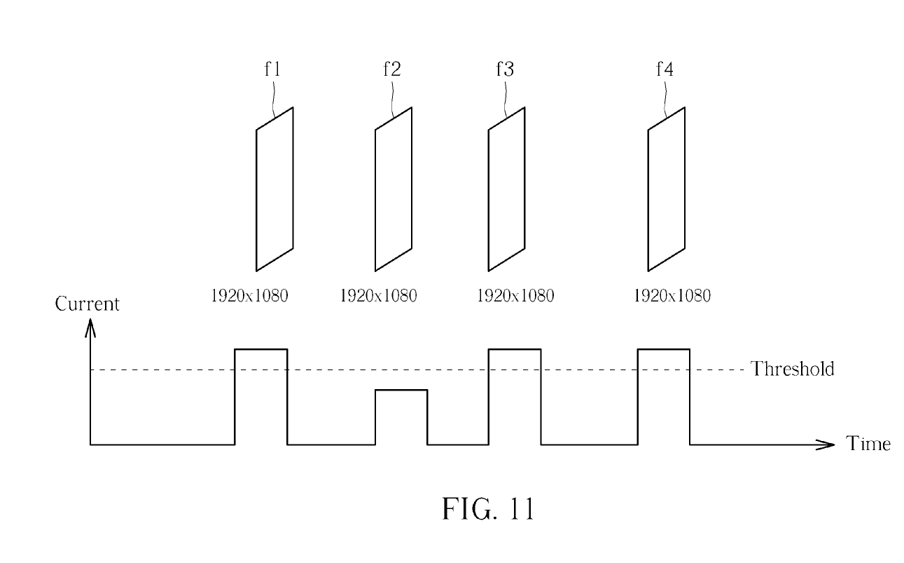

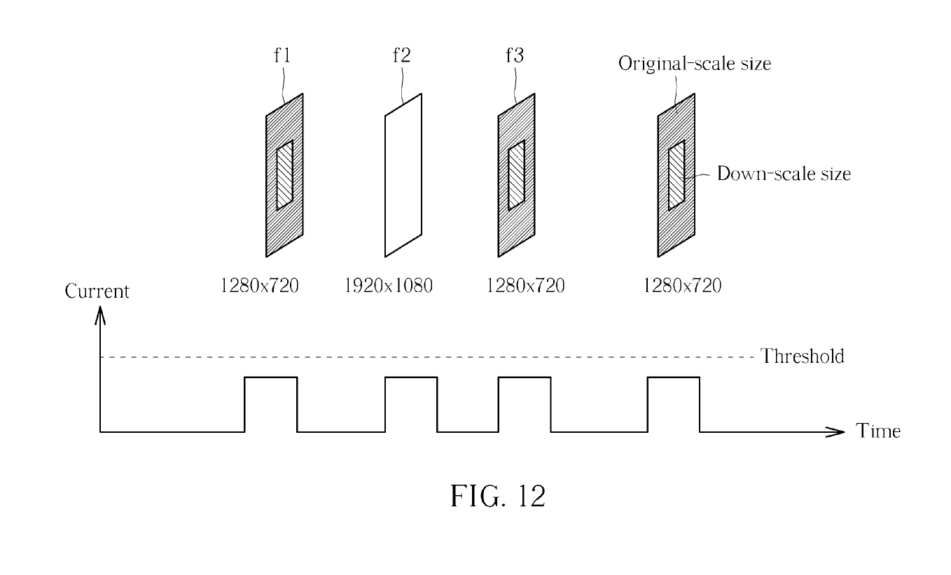

In the embodiments of FIG. 11 and FIG. 12, the device parameter includes a current value, and the operating parameter includes a frame resolution. In the embodiments of FIG. 11 and FIG. 12, the frame resolution of the image signal processor 403 in FIG. 4 is adjusted. However, the combination of the current and the frame resolution can be applied to any other device(s) (e.g. encoder, memory device) of the image/video processing module other than the image signal processor.

Please refer to FIG. 11, the frame resolutions for the timings that the image signal processor processes frames f1, f2, f3, f4 are all 1920×1080, and the current values for the timings that the image signal processor processes frames f1, f3, f4 are over a current threshold value. Accordingly, in the embodiment of FIG. 12, the frame resolutions for the timings that the image signal processor processes frames f1, f3, f4 are adjusted to 1280×720. By this way, the current values for the timings that the image signal processor processes frames f1, f3, f4 may be lower than the current threshold value correspondingly.

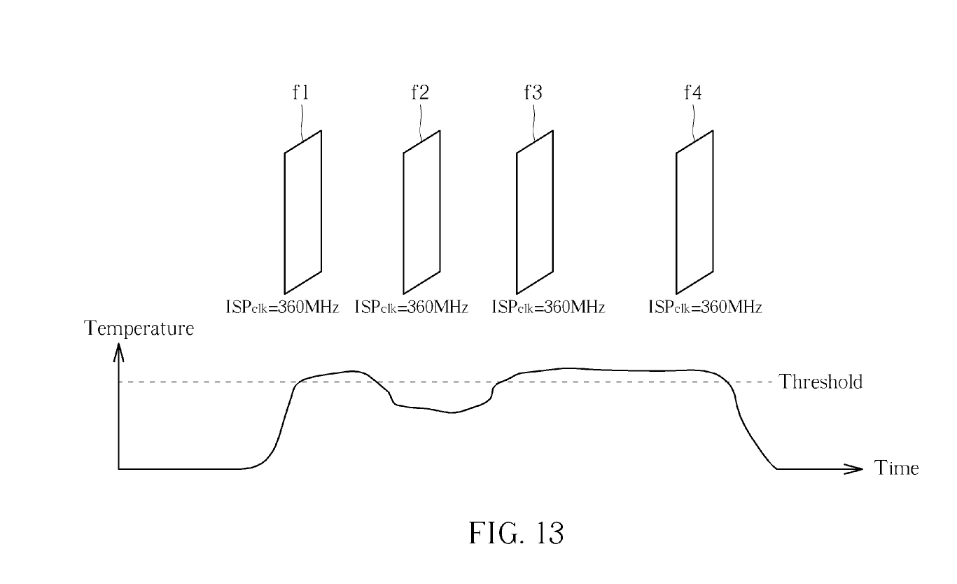

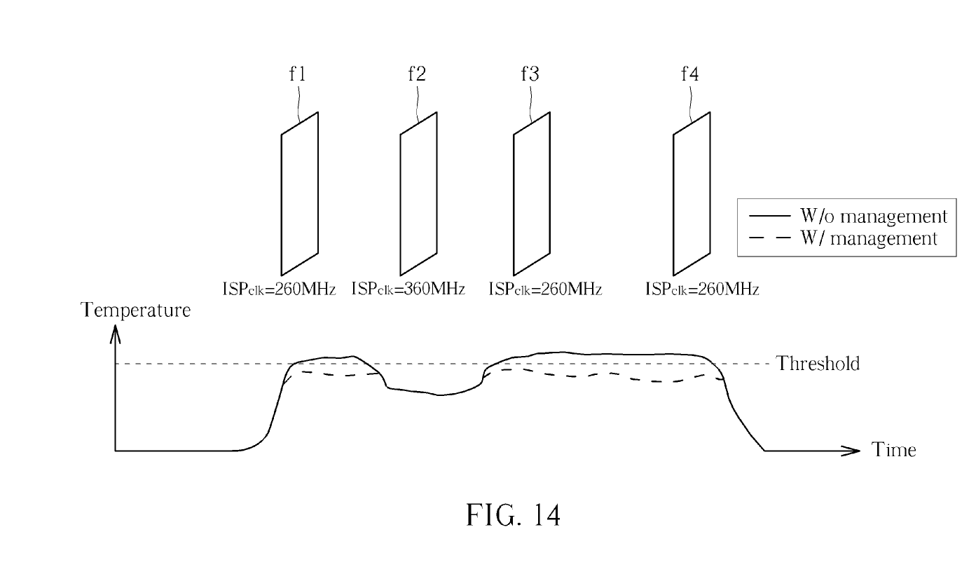

In the embodiments of FIG. 13 and FIG. 14, the device parameter includes a temperature, and the operating parameter includes an operating speed. In one embodiment, the operating speed is adjusted via adjusting a clock rate, but not limited. Further, in the embodiments of FIG. 13 and FIG. 14, the operating speed of the image signal processor 403 (ISP_{clk}) in FIG. 4 is adjusted. However, the combination of the current and the operating speed can be applied to any other device(s) (e.g. encoder) of the image/video processing module other than the image signal processor.

Please refer to FIG. 13, the clock rates for the timings that the image signal processor processes frames f1, f2, f3, f4 are all 360 MHz, and the temperatures for the timings that the image signal processor processes frames f1, f3, f4 are over a temperature threshold value. Accordingly, in the embodiment of FIG. 14, the clock rates for the timings that the image signal processor processes frames f1, f3, f4 are adjusted to 260 MHz. By this way, the temperatures for the timings that the image signal processor processes frames f1, f3, f4 may be lower than the temperature threshold value correspondingly.

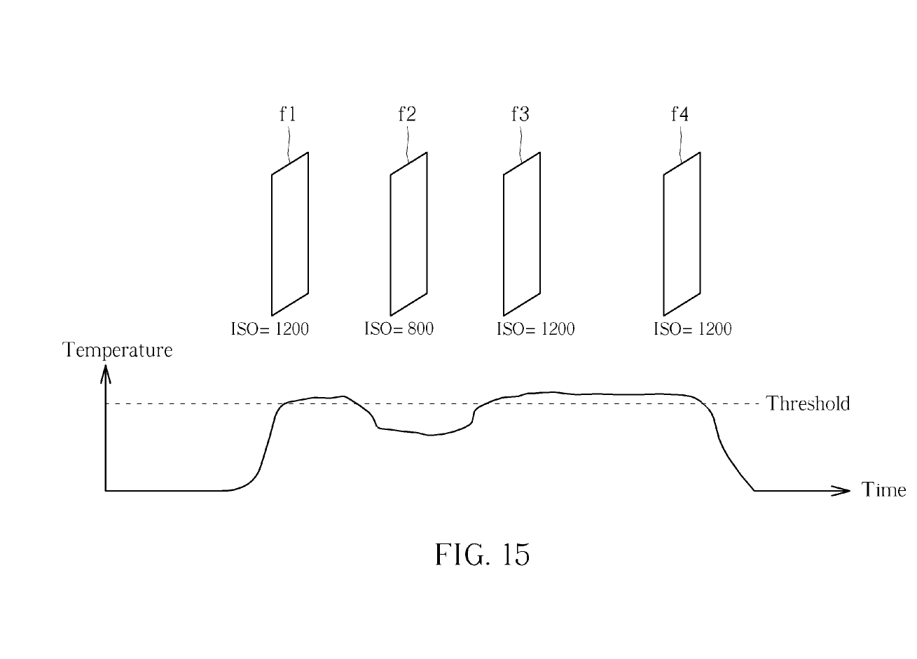

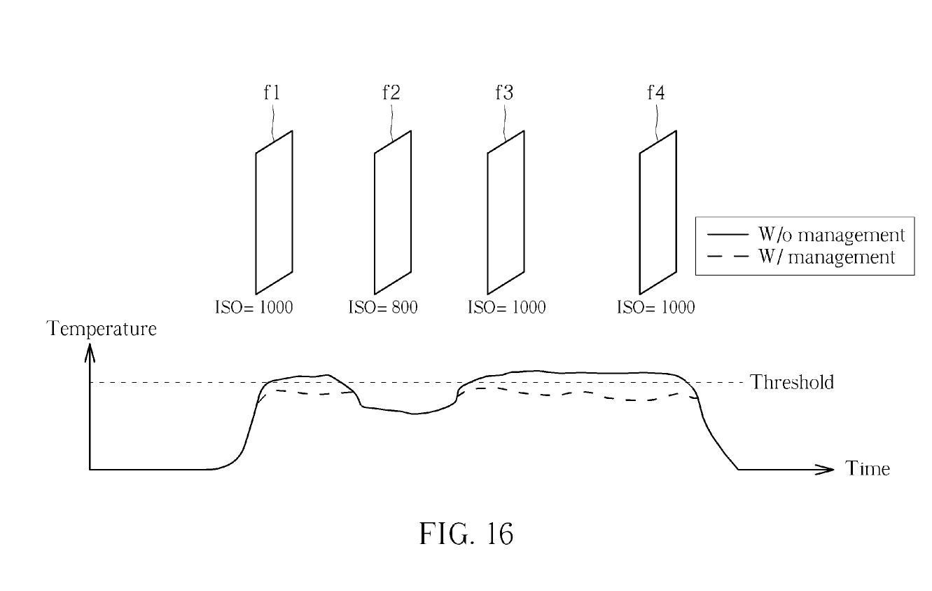

In the embodiments of FIG. 15 and FIG. 16, the device parameter is a temperature, and the operating parameter is an ISO value. In the embodiments of FIG. 15 and FIG. 16, the ISO value of the image signal processor 403 in FIG. 4 is adjusted. However, the combination of the temperature and the ISO value can be applied to any other device(s) of the image/video processing module other than the image signal processor.

Please refer to FIG. 15, the ISO values for the timings that the image signal processor processes frames f1, f3, f4 are 1200, and the ISO value for the timing that the image signal processor processes the frame f2 is 800. For such case, the temperatures for the timings that the image signal processor processes frames f1, f3, f4 are over a temperature threshold value. Accordingly, in the embodiment of FIG. 16, the ISO values for the timings that the image signal processor processes frames f1, f3, f4 are adjusted to 1000. By this way, the temperatures for the timings that the image signal processor processes frames f1, f3, f4 may be lower than the temperature threshold value correspondingly.

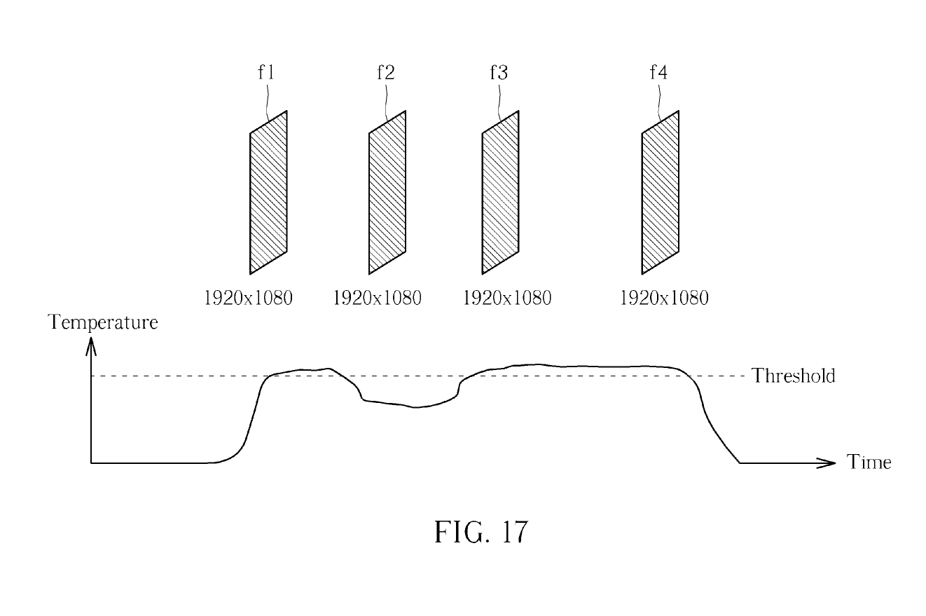

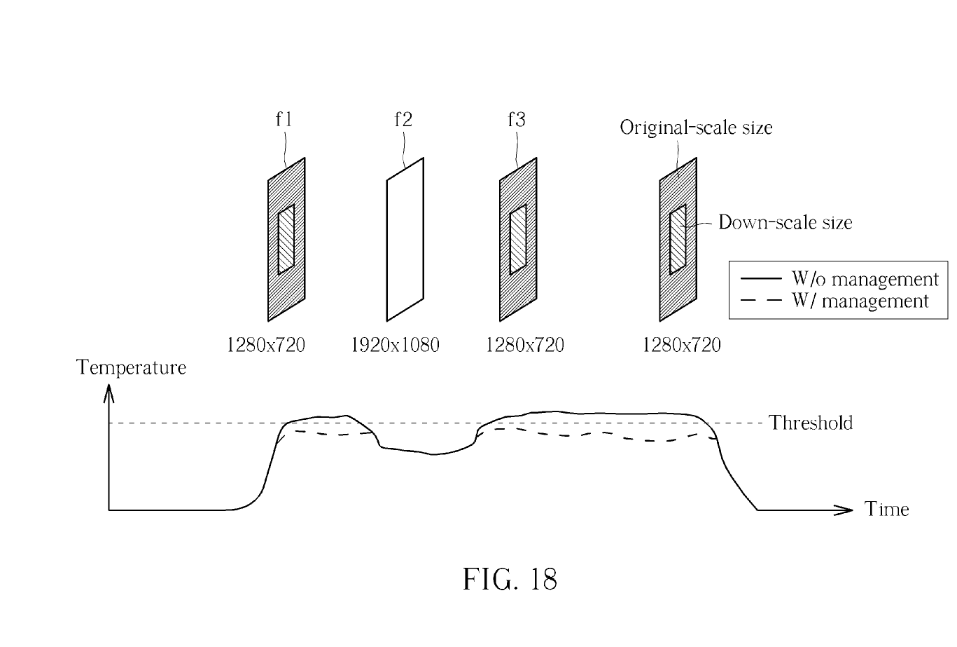

In the embodiments of FIG. 17 and FIG. 18, the device parameter includes a temperature, and the operating parameter includes a frame resolution. In the embodiments of FIG. 17 and FIG. 18, the frame resolution of the image signal processor 403 in FIG. 4 is adjusted. However, the combination of the temperature and the frame resolution can be applied to any other device(s) of the image/video processing module other than the image signal processor.

Please refer to FIG. 17, the frame resolutions for the timings that the image signal processor processes frames f1, f2, f3, f4 are all 1920×1080, and the temperatures for the timings that the image signal processor processes frames f1, f3, f4 are over a temperature threshold value. Accordingly, in the embodiment of FIG. 18, the frame resolutions for the timings that the image signal processor processes frames f1, f3, f4 are adjusted to 1280×720. By this way, the temperatures for the timings that the image signal processor processes frames f1, f3, f4 can be adjusted to be lower than the temperature threshold value.

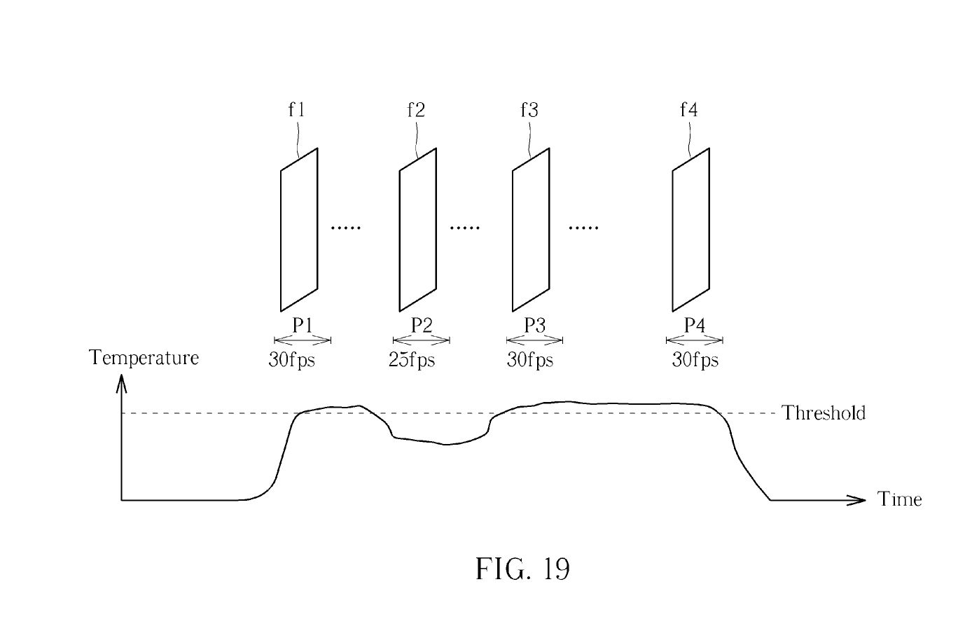

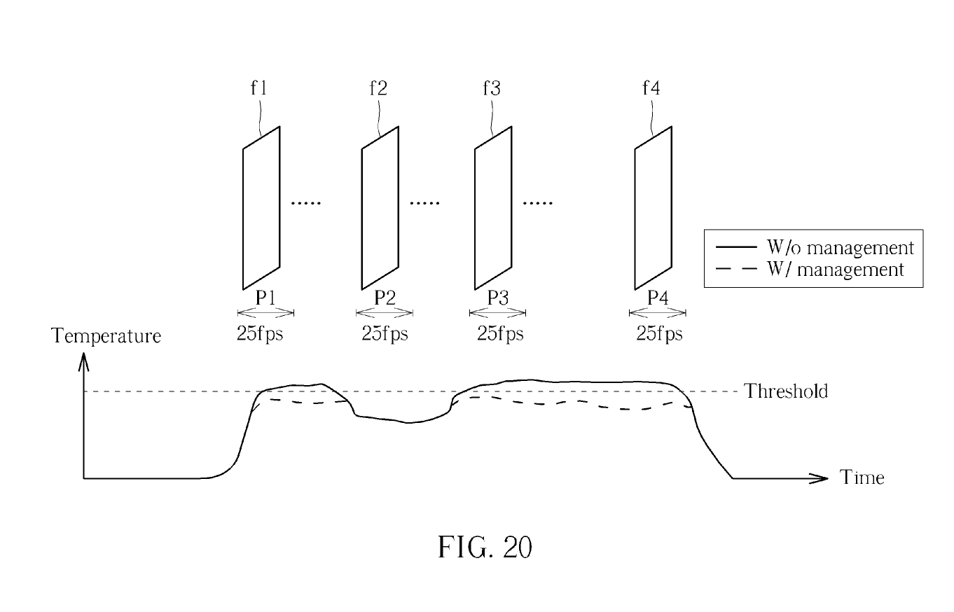

In the embodiments of FIG. 19 and FIG. 20, the device parameter includes a temperature, and the operating parameter includes a frame rate. In the embodiments of FIG. 19 and FIG. 20, the frame rate of the image sensor 401 in FIG. 4 is adjusted. However, the combination of the temperature and the frame rate can be applied to any other device(s) of the image/video processing module other than the image sensor.

Please refer to FIG. 19, the frame rates for the time periods P1, P3 and P4 are all 30 fps, and the frame rate for the time period P2 is 25 fps. For such case, the temperatures for the time periods P1, P3 and P4 are over a temperature threshold value. Accordingly, in the embodiment of FIG. 20, the frame rates for the time periods P1, P3 and P4 are adjusted to 25 fps. By this way, the temperatures for the time periods P1, P3 and P4 may be lower than the temperature threshold value correspondingly.

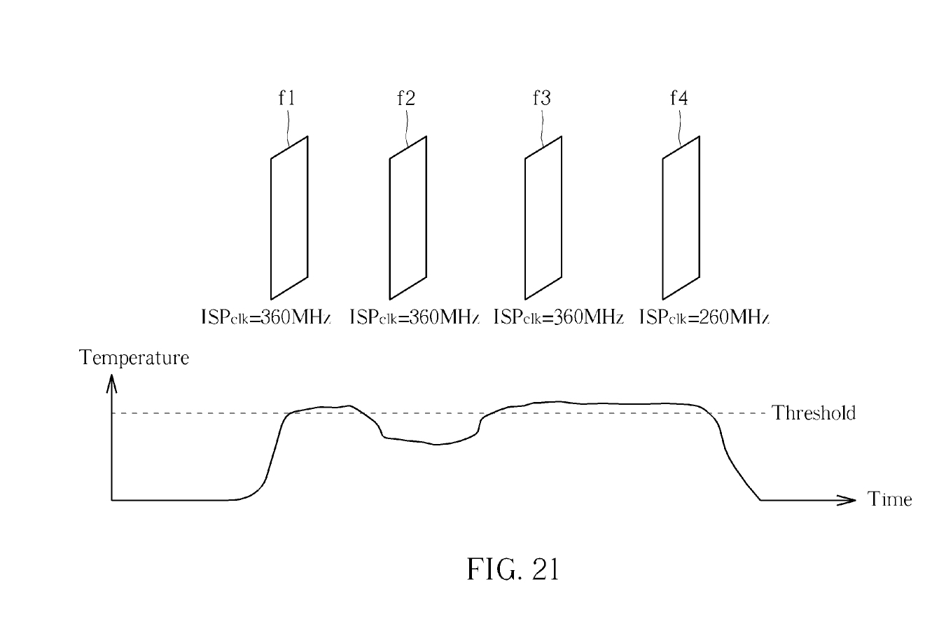

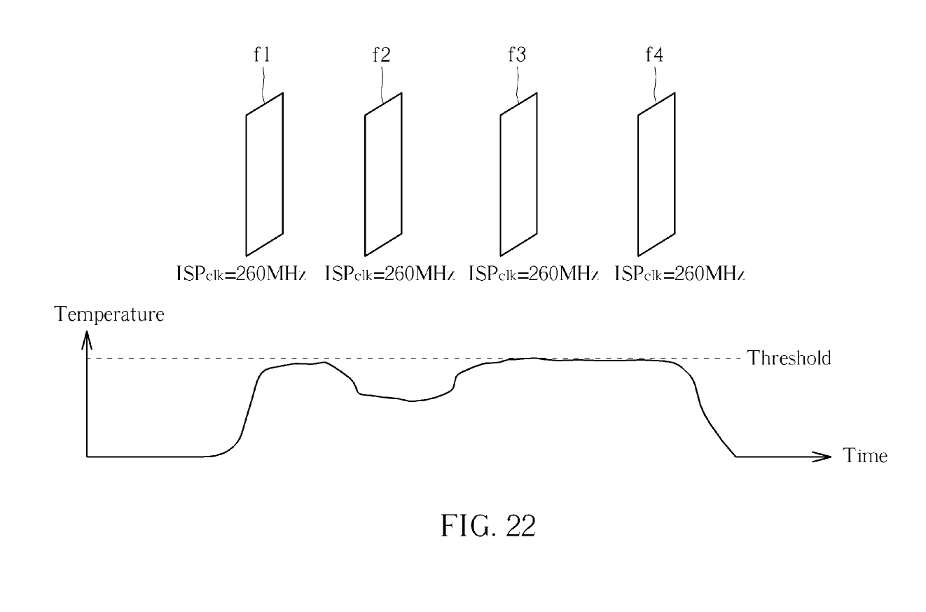

In the embodiments of FIG. 21 and FIG. 22, the device parameter includes a frame resolution or a frame rate, and the operating parameter includes an operating speed. In one embodiment, the operating speed is adjusted via adjusting a clock rate, but not limited. Further, in the embodiments of FIG. 21 and FIG. 22, the operating speed of the image signal processor 403 (ISP_{clk}) in FIG. 4 is adjusted. However, the combination of the frame resolution/frame rate and the operating speed can be applied to any other device(s) (e.g. encoder) of the image/video processing module other than the image signal processor. Further, in the embodiments of FIG. 21 and FIG. 22, the frame resolution is 4k and the frame rate is 60 fps.

Please refer to FIG. 21, the clock rates for the timings that the image signal processor processes frames f1, f2, f3, f4 are all 360 MHz, and the temperatures for the timings that the image signal processor processes frames f1, f3, f4 are over a temperature threshold value. In the embodiment of FIG. 22, the clock rates for the timings that the image signal processor processes frames f1, f2, f3, f4 are all adjusted to 260 MHz since the frame resolution or the frame rate is over a frame resolution threshold value or a frame rate threshold value. Thereby the temperatures for the timings that the image signal processor processes frames f1, f2, f3, f4 are all adjusted to be lower. Please note, in the embodiment of FIG. 13, only the clock rates for the timings that the image signal processor processes frames f1, f3, f4 are adjusted since the adjusting of the clock rate is based on the temperature. However, in the embodiment of FIG. 22, the clock rates for the timings that the image signal processor processes frames f1, f2, f3, f4 are all adjusted since the adjusting of the clock rate may be based on the frame rate or the frame resolution.

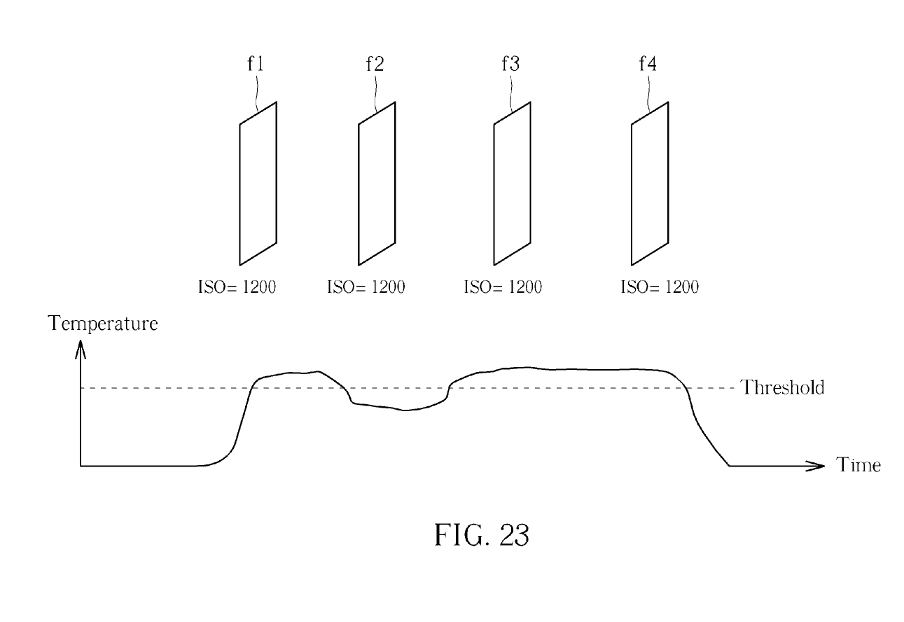

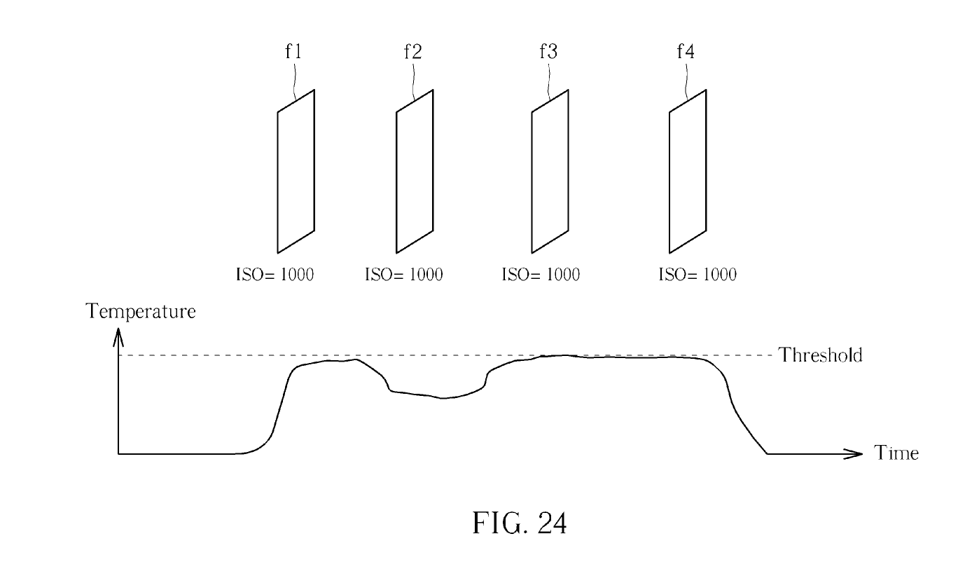

In the embodiments of FIG. 23 and FIG. 24, the device parameter includes a frame resolution or a frame rate, and the operating parameter includes an ISO value. In the embodiments of FIG. 23 and FIG. 24, the ISO value of the image signal processor 403 in FIG. 4 is adjusted. However, the combination of the frame resolution/frame rate and the ISO value can be applied to any other device(s) of the image/video processing module other than the image signal processor. Further, in the embodiments of FIG. 23 and FIG. 24, the frame resolution is 4k and the frame rate is 60 fps.

Please refer to FIG. 23, the ISO values for the timings that the image signal processor processes frames f1, f2, f3, f4 are all 1200, and the temperatures for the timings that the image signal processor processes frames f1, f3, f4 are over a temperature threshold value. In the embodiment of FIG. 24, the ISO values for the timings that the image signal processor processes frames f1, f2, f3, f4 are all adjusted to 1000 since the frame resolution or the frame rate is over a frame resolution threshold value or a frame rate threshold value. Thereby the temperatures for the timings that the image signal processor processes frames f1, f2, f3, f4 may be lower correspondingly. Please note, in the embodiment of FIG. 16, only the ISO values for the timings that the image signal processor processes frames f1, f3, f4 are adjusted since the adjusting of the ISO value is based on the temperature. However, in the embodiment of FIG. 24, the ISO values for the timings that the image signal processor processes frames f1, f2, f3, f4 are all adjusted since the adjusting of the clock rate may be based on the frame rate or the frame resolution.

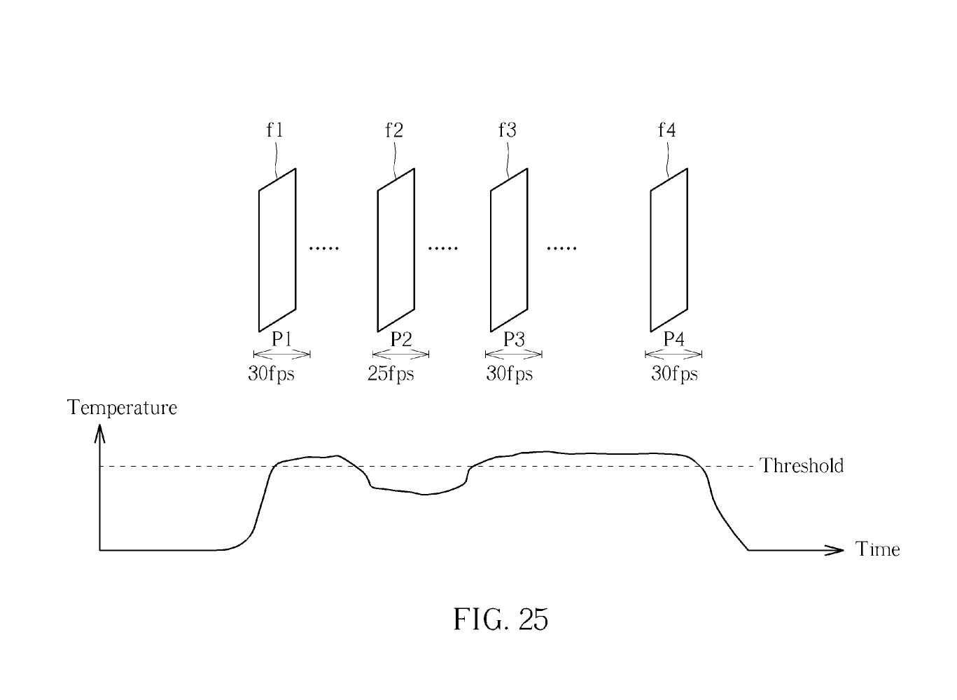

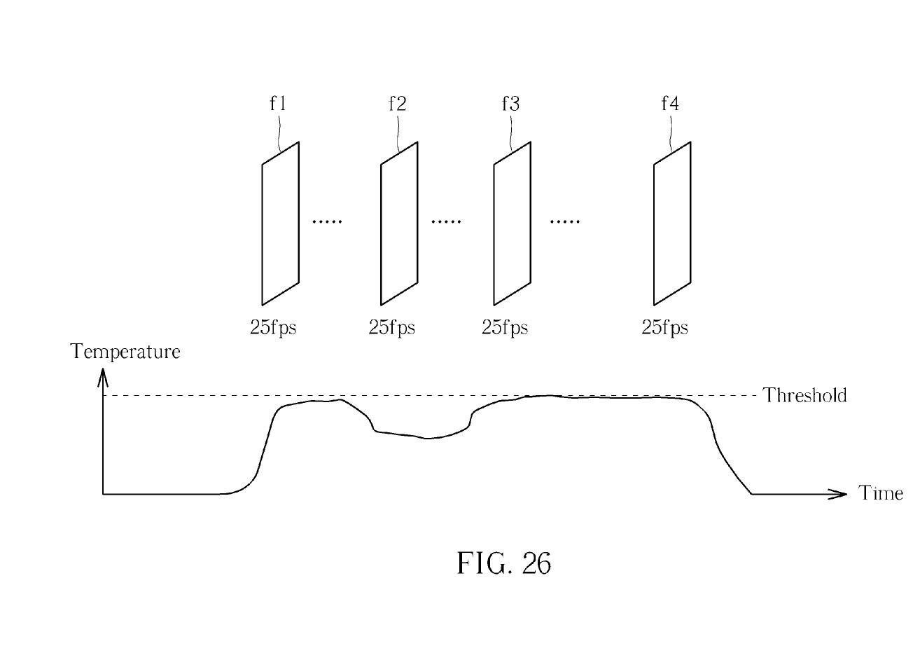

In the embodiments of FIG. 25 and FIG. 26, the device parameter includes a frame resolution or an ISO value, and the operating parameter includes a frame rate. In the embodiments of FIG. 25 and FIG. 26, the frame rate of the image sensor 401 in FIG. 4 is adjusted. However, the combination of the frame resolution/ISO value and the frame rate can be applied to any other device(s) of the image/video processing module other than the image sensor. Further, in the embodiments of FIG. 25 and FIG. 26, the frame resolution is 4k and the ISO value is 1200.

Please refer to FIG. 25, the frame rates for the time periods P1, P2, P3, P4 are all 30 fps, and the temperatures for the time periods P1, P3 and P4 are over a current threshold value. In the embodiment of FIG. 26, the frame rates for the time periods P1, P2, P3, P4 are all adjusted to 25 fps since the frame resolution or the ISO value is over a frame resolution threshold value or an ISO threshold value. Thereby the temperatures for the time periods P1, P2, P3, P4 may be lower correspondingly. Please note, in the embodiment of FIG. 26, the frame rates for the time periods P1, P2, P3, P4 are all adjusted since the adjusting of the frame rate may be based on the frame resolution or the ISO value, rather than the temperature.

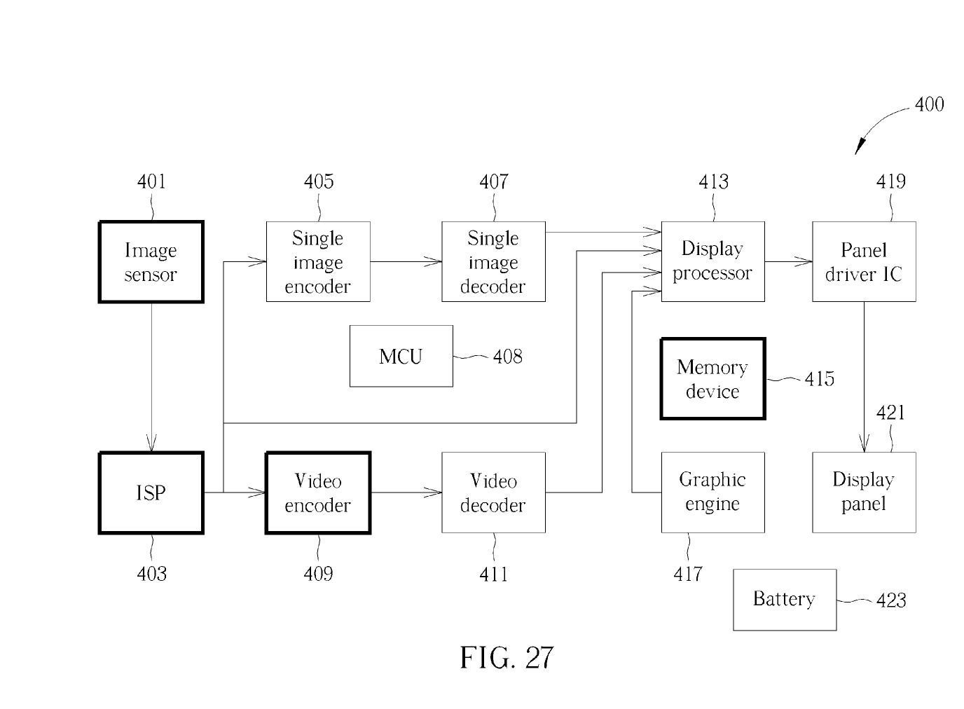

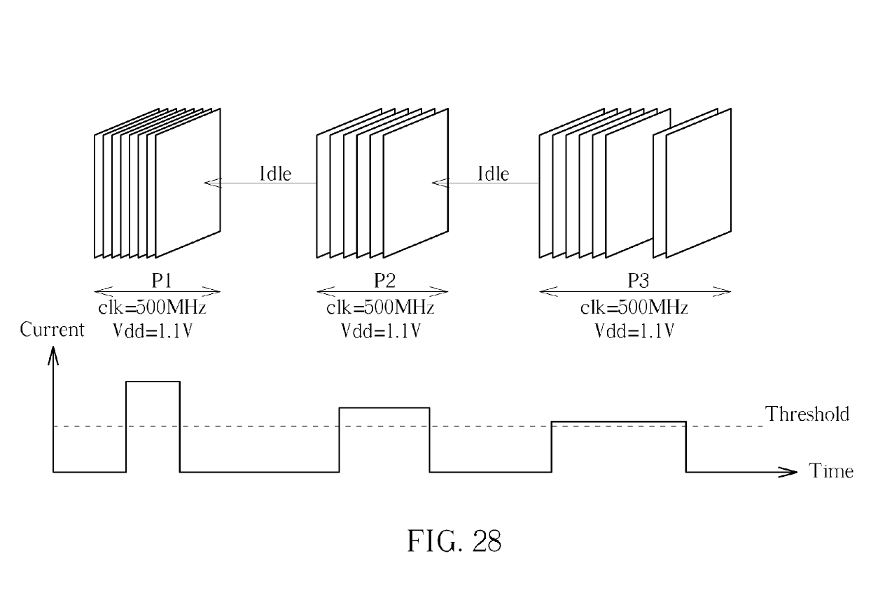

If the image/video processing module is applied to record video data or configured for an video recording device, the devices that tend to generate thermal may include: the image sensor 401, the image signal processor 403, the video encoder 409, the memory device 415 or combination thereof, as depicted in FIG. 27. Therefore, these devices are applied as examples in the embodiments depicted in FIG. 28-FIG. 50. Please note these examples are only for explaining and do not mean to limit the scope of the present invention.

Please refer to FIG. 5 and FIG. 6 again, the steps depicted in FIG. 5 and FIG. 6 and related examples can be applied to the embodiment depicted in FIG. 27. However, please note if the step 507 is applied to the embodiment depicted in FIG. 27, the step 507 measures the device parameter for at least one of: the image sensor 401, the image signal processor 403, the video encoder 409, the memory device 415 or combination thereof, which are marked in FIG. 27.

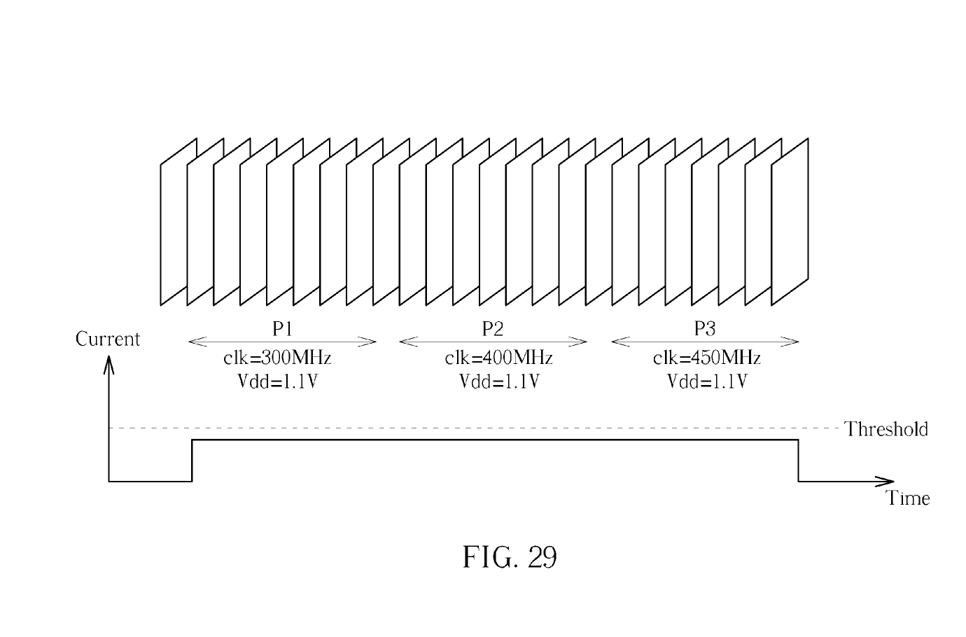

In the embodiments of FIG. 28 and FIG. 29, the device parameter includes a current value, and the operating parameter includes an operating speed. In one embodiment, the operating speed is adjusted via adjusting a clock rate (clk), but not limited. Further, in the embodiments of FIG. 28 and FIG. 29, the operating speed of the image signal processor 403 in FIG. 27 is adjusted. However, the combination of the current and the operating speed can be applied to any other device(s) (e.g. encoder) of the image/video processing module other than the image signal processor.

Please refer to FIG. 28, in each of time periods P1, P2, P3, a plurality of frames are processed by the image signal processor 403. The clock rates for the time periods P1, P2, P3 are all 500 MHz, and the current values for the time periods P1, P2, P3 are over a current threshold value. Accordingly, in the embodiment of FIG. 28, the clock rates for the time periods P1, P2, P3 are respectively adjusted to 300 MHz, 400 MHz and 450 MHz. By this way, the current values for the timings that the time periods P1, P2, P3 may be lower than the current threshold value correspondingly.

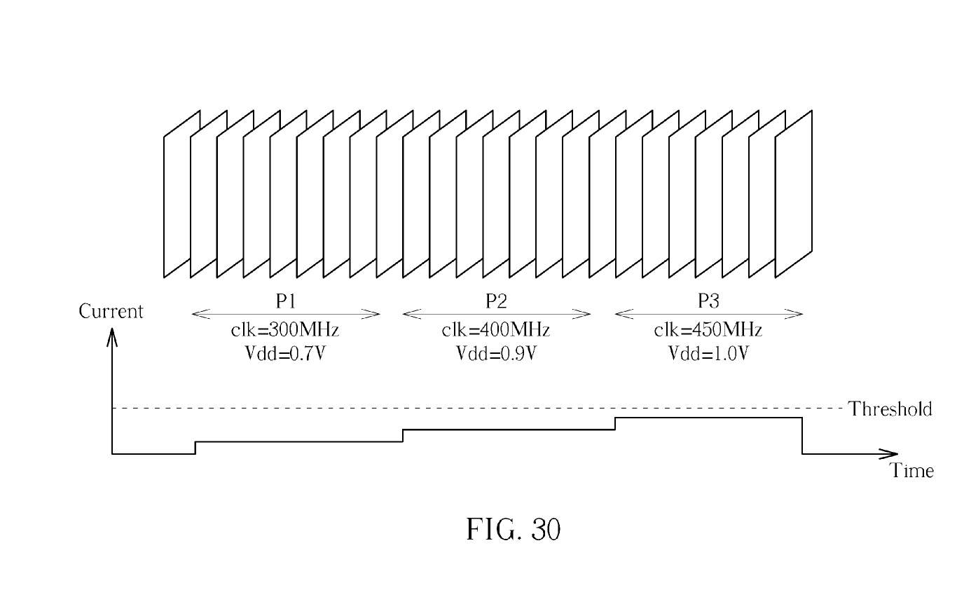

In one embodiment, the operating voltage for the image signal processor is also adjusted to further reduce the current values. Following the embodiment of FIG. 29, the embodiment of FIG. 30 further adjusts the operating voltage Vdd from 1.1v respectively to 0.7v, 0.9v and 1.0v for the time periods P1, P2, and P3. Thereby the currents for the time periods P1, P2, and P3 can be further reduced. Please note the operation for adjusting the operating voltage Vdd is not limited to adjust the operating voltage under the situation depicted in FIG. 29. For example, the operating voltage Vdd for the embodiment depicted in FIG. 28 can be adjusted as well to reduce the current values.

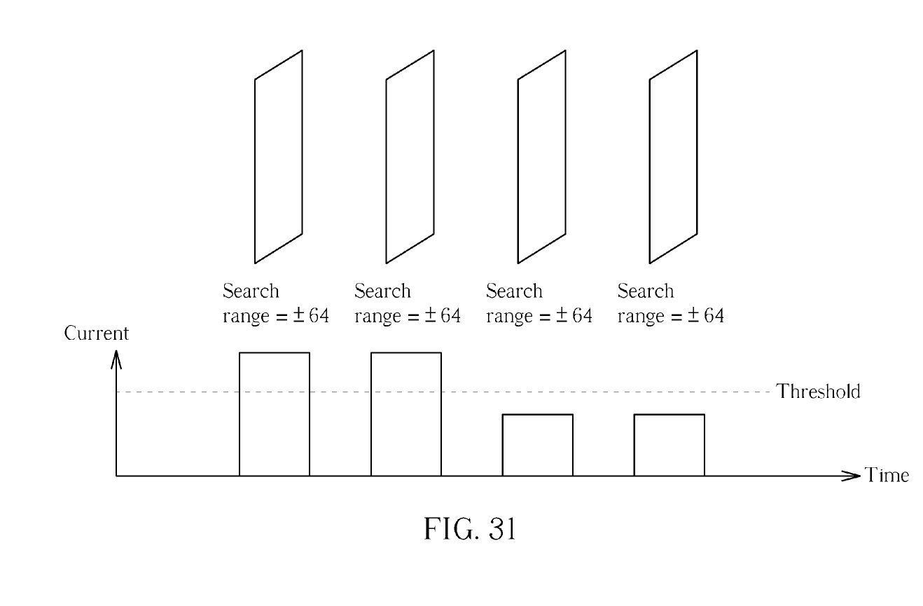

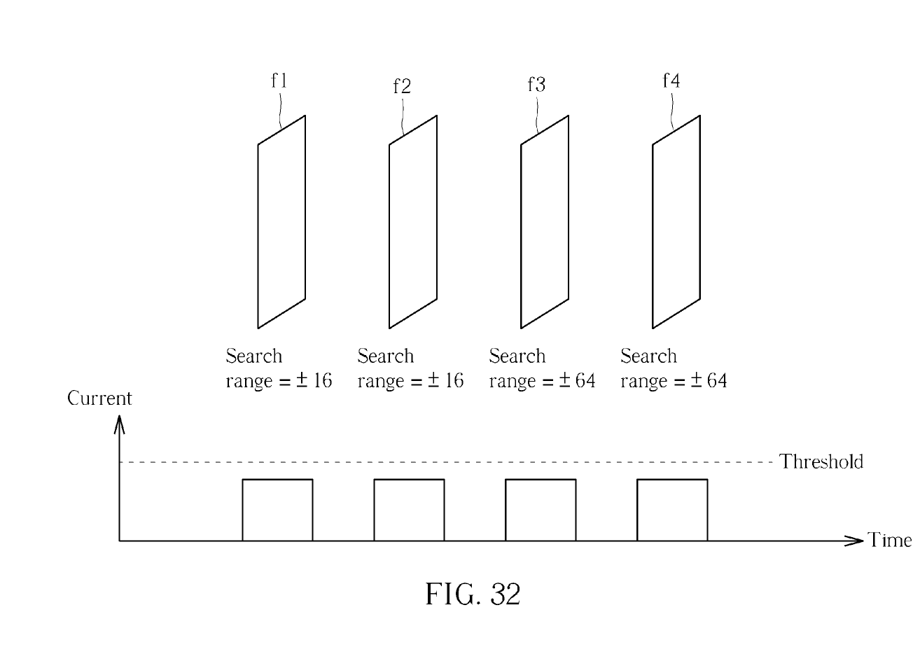

In the embodiments of FIG. 31 and FIG. 32, the device parameter includes a current value, and the operating parameter includes a maximum motion search range (e.g. a motion searching window, but not limited). In the embodiments of FIG. 31 and FIG. 32, the maximum motion search range of the video encoder 409 in FIG. 27 is adjusted. However, the combination of the current and the maximum motion search range can be applied to any other device(s) of the image/video processing module other than the video encoder.

Please refer to FIG. 31, the maximum motion search ranges for the timings that the video encoder processes frames f1, f2, f3, f4 are all 64 pixels, and the current values for the timings that the video encoder processes frames f1, f2 are over a current threshold value. Accordingly, in the embodiment of FIG. 32, the maximum motion search ranges for the timings that the image signal processor processes frames f1, f2 are adjusted to 16. By this way, the current values for the timings that the image signal processor processes frames f1, f2 may be lower than the current threshold value correspondingly.

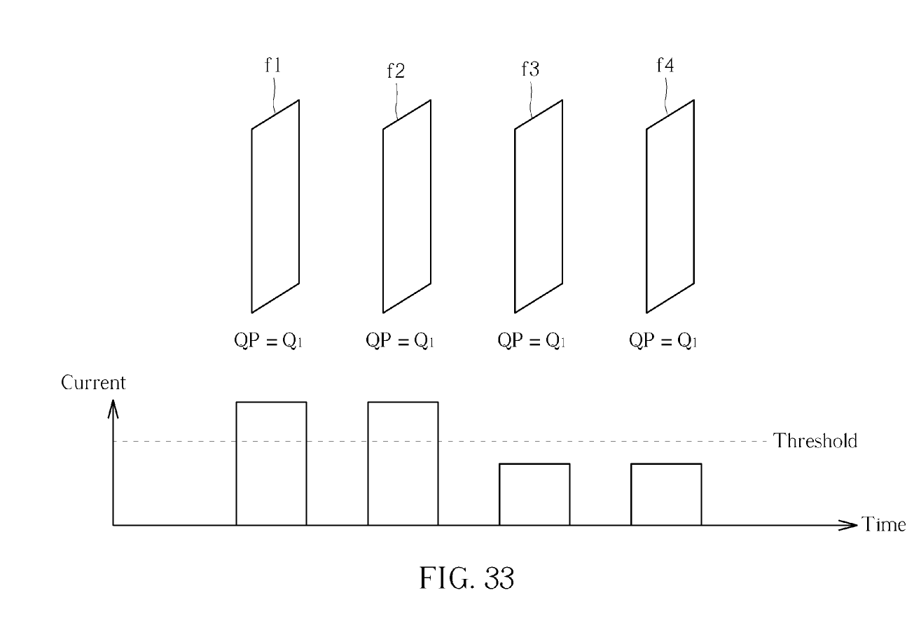

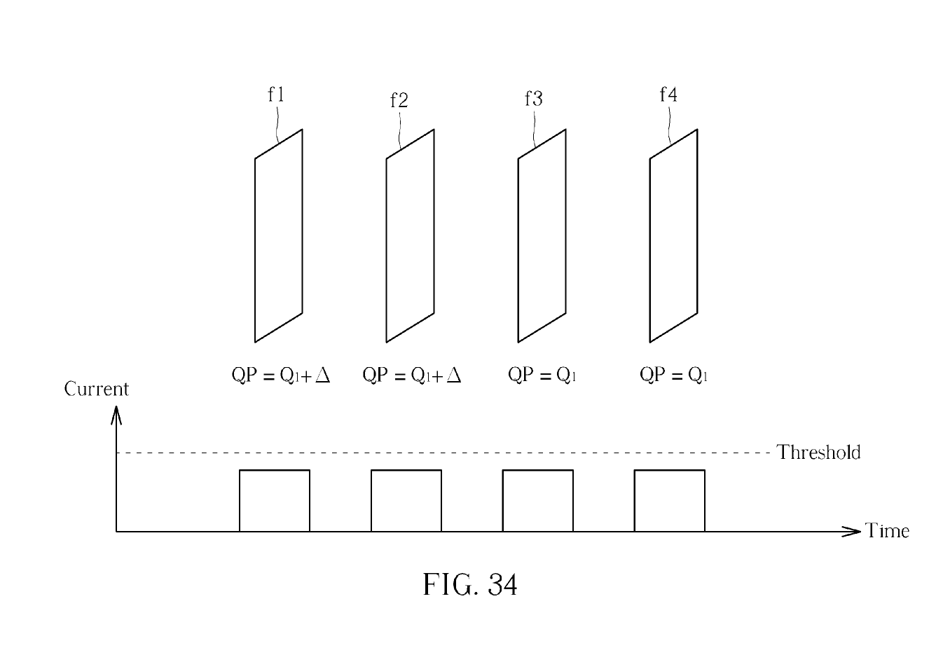

In the embodiments of FIG. 33 and FIG. 34, the device parameter includes a current value, and the operating parameter includes a quantization parameter, which is a parameter indicates a quantization level of the frame. In the embodiments of FIG. 33 and FIG. 34, the quantization parameter of the video encoder 409 in FIG. 27 is adjusted. However, the combination of the current and the quantization parameter can be applied to any other device(s) of the image/video processing module other than the video encoder.

Please refer to FIG. 33, the quantization parameters for the timings that the video encoder processes frames f1, f2, f3, f4 are all Q1, and the current values for the timings that the video encoder processes frames f1, f2 are over a current threshold value. Accordingly, in the embodiment of FIG. 34, the quantization parameters for the timings that the image signal processor processes frames f1, f2 are adjusted/increased to Q1+Δ. The Δ is a positive value. By this way, the current values for the timings that the image signal processor processes frames f1, f2 may be lower than the current threshold value correspondingly.

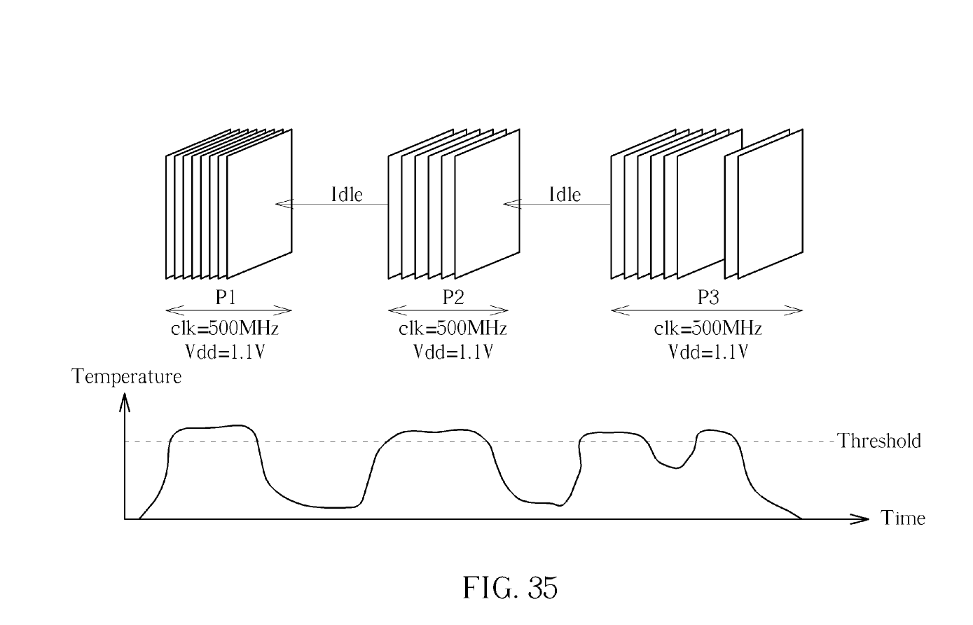

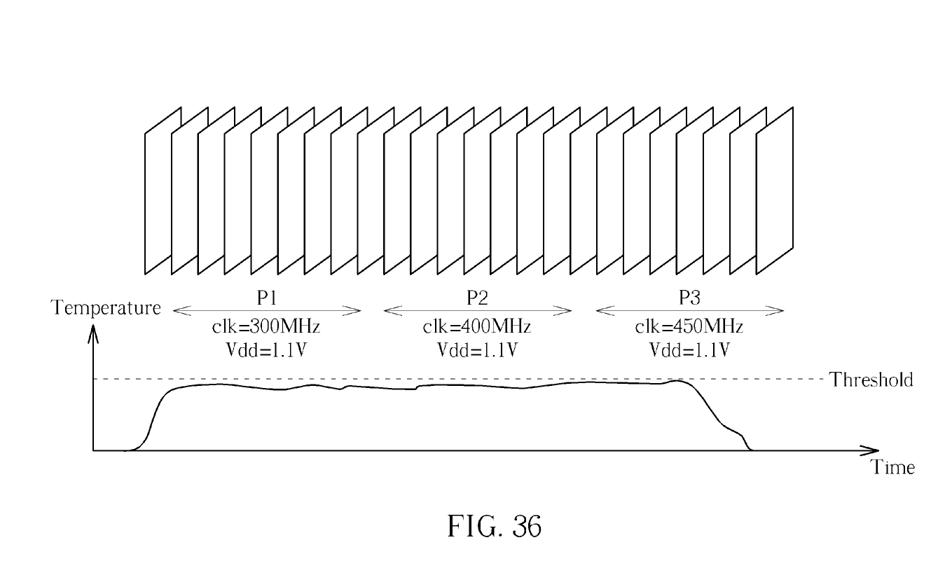

In the embodiments of FIG. 35 and FIG. 36, the device parameter includes a temperature, and the operating parameter includes an operating speed. In one embodiment, the operating speed is adjusted via adjusting a clock rate, but not limited. Further, in the embodiments of FIG. 35 and FIG. 36, the operating speed of the image signal processor 403 (clk) in FIG. 27 is adjusted. However, the combination of the temperature and the operating speed can be applied to any other device(s) (e.g. encoder) of the image/video processing module other than the image signal processor.

Please refer to FIG. 35, in each of time periods P1, P2, P3, a plurality of frames are processed by the image signal processor 403. The clock rates for the time periods P1, P2, P3 are all 500 MHz, and the temperatures for the time periods P1, P2, P3 are over a temperature threshold value. Accordingly, in the embodiment of FIG. 36, the clock rates for the time periods P1, P2, P3 are adjusted to 300 MHz, 400 MHz and 450 MHz. By this way, the temperatures for the timings that the time periods P1, P2, P3 may be lower than the temperature threshold value correspondingly.

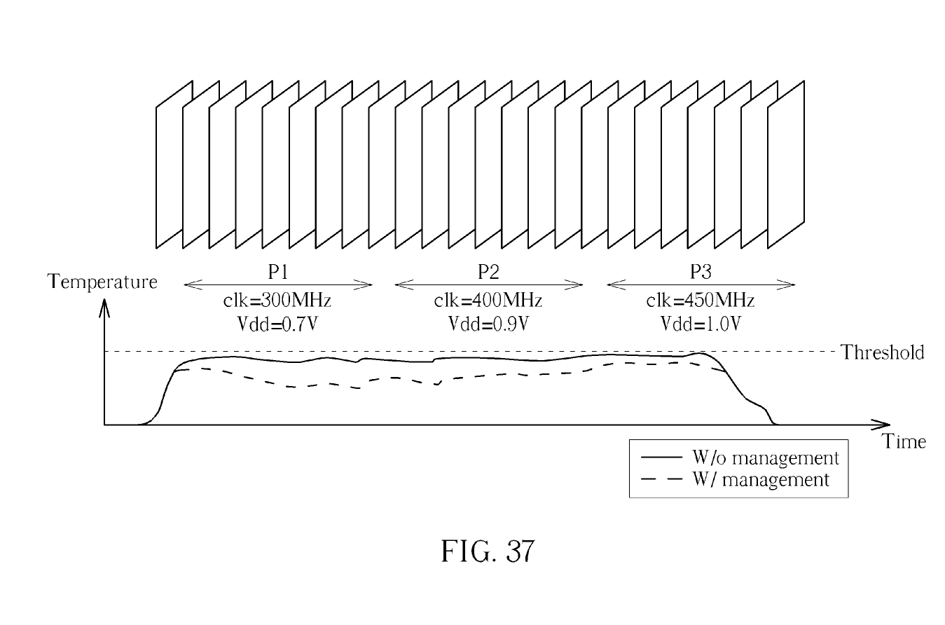

In one embodiment, the operating voltage is adjusted to further reduce the temperatures. Following the embodiment of FIG. 36, the embodiment of FIG. 37 further adjusts the operating voltage Vdd from 1.1v respectively to 0.7v, 0.9v and 1.0v for the time periods P1, P2, and P3. Thereby the temperatures for the time periods P1, P2, and P3 can be further reduced. Please note the operation for adjusting the operating voltage Vdd is not limited to adjust the operating voltage under the situation depicted in FIG. 36. For example, the operating voltage Vdd for the embodiment depicted in FIG. 35 can be adjusted as well to reduce the temperatures.

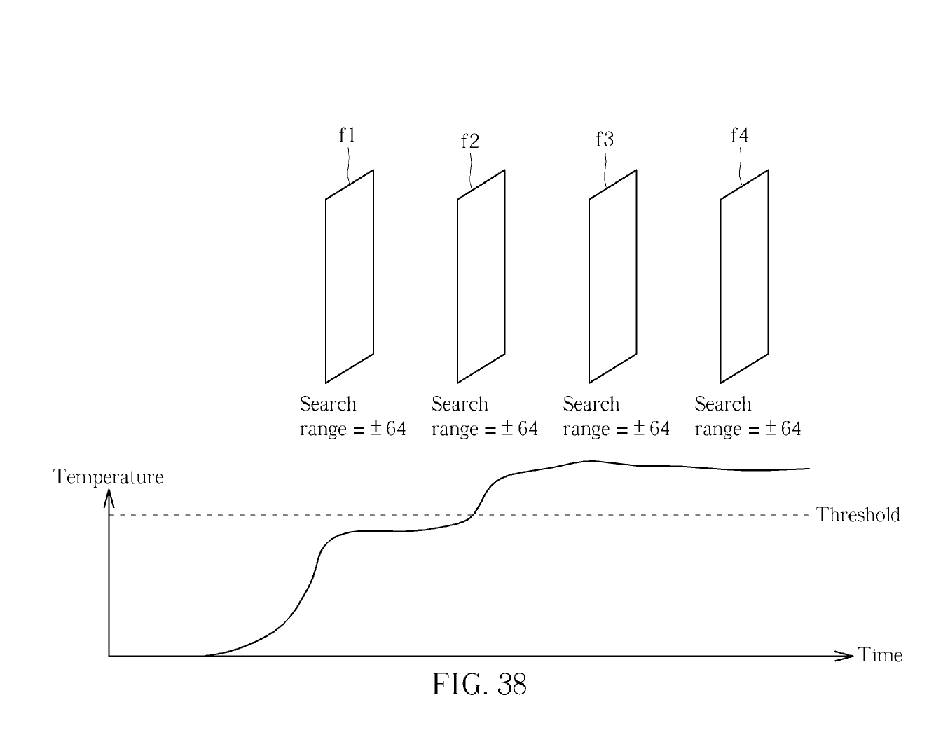

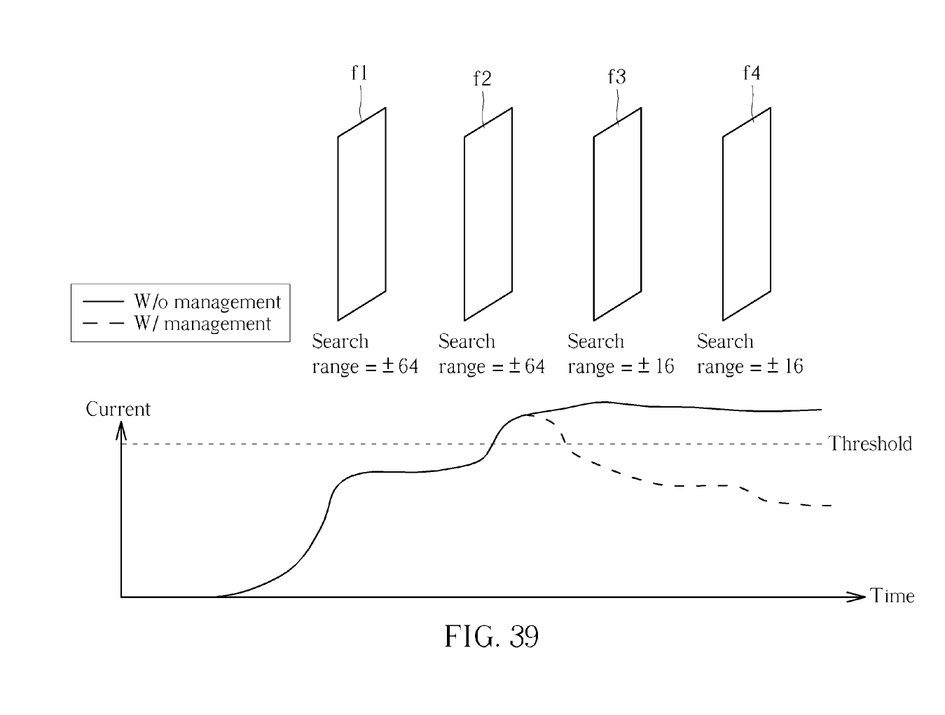

In the embodiments of FIG. 38 and FIG. 39, the device parameter includes a temperature, and the operating parameter includes a maximum motion search range (e.g. a motion searching window, but not limited). In the embodiments of FIG. 38 and FIG. 39, the maximum motion search range of the video encoder 409 in FIG. 27 is adjusted. However, the combination of the temperature and the maximum motion search range can be applied to any other device(s) of the image/video processing module other than the video encoder.

Please refer to FIG. 38, the maximum motion search ranges for the timings that the video encoder processes frames f1, f2, f3, f4 are all 64 pixels, and the temperatures for the timings that the video encoder processes frames f3, f4 are over a temperature threshold value. Accordingly, in the embodiment of FIG. 39, the maximum motion search ranges for the timings that the image signal processor processes frames f3, f4 are adjusted to 16. By this way, the temperatures for the timings that the image signal processor processes frames f3, f4 may be lower than the temperature threshold value correspondingly.

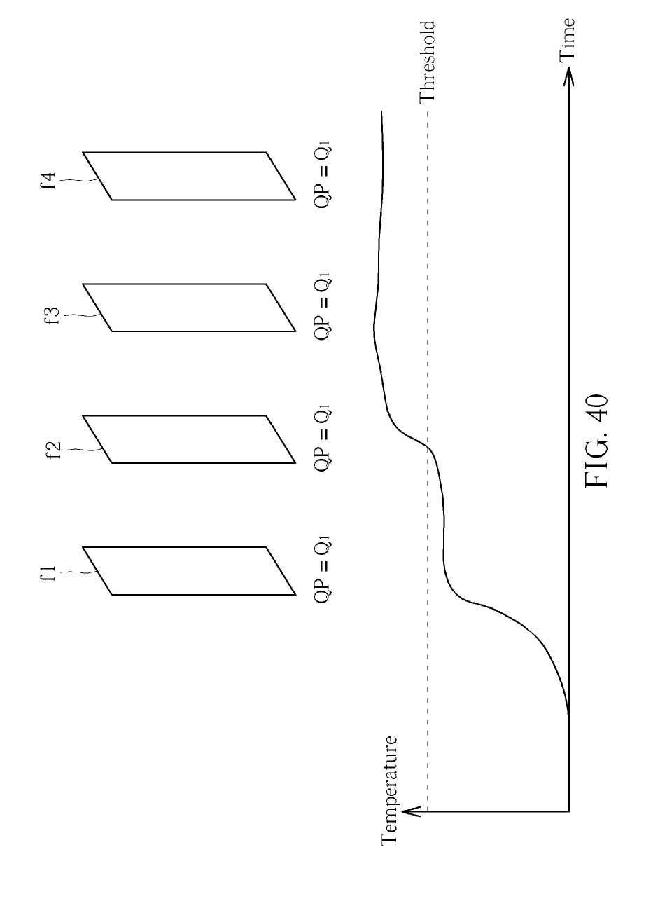

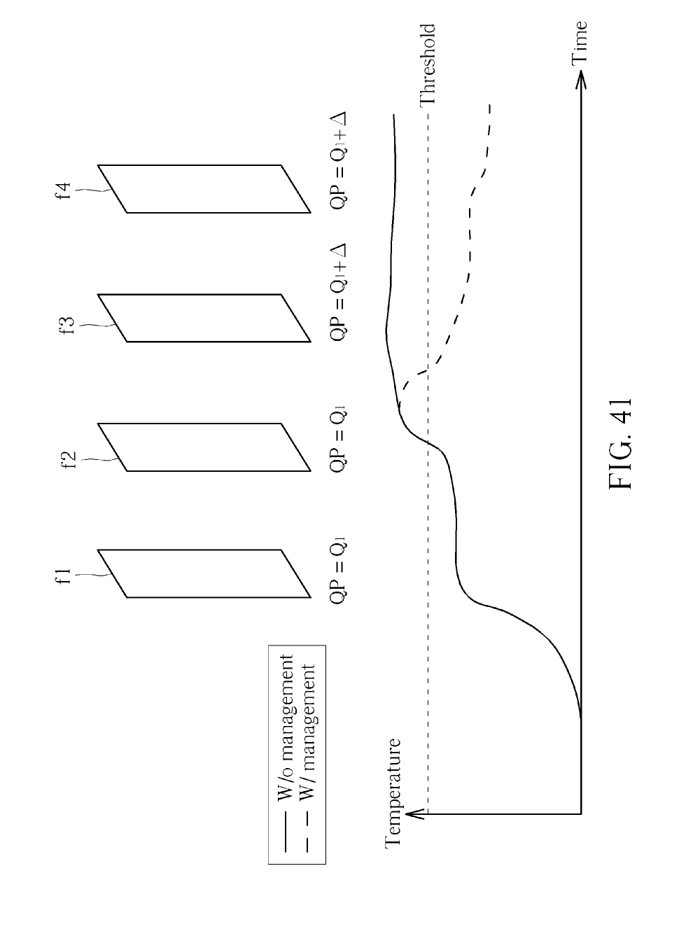

In the embodiments of FIG. 40 and FIG. 41, the device parameter includes a temperature, and the operating parameter includes a quantization parameter, which is a parameter indicates a quantization level of the frame. In the embodiments of FIG. 40 and FIG. 41, the quantization parameter of the video encoder 409 in FIG. 27 is adjusted. However, the combination of the temperature and the quantization parameter can be applied to any other device(s) of the image/video processing module other than the video encoder.

Please refer to FIG. 40, the quantization parameters for the timings that the video encoder processes frames f1, f2, f3, f4 are all Q1, and the temperatures for the timings that the image signal processor processes frames f3, f4 are over a temperature threshold value. Accordingly, in the embodiment of FIG. 41, the quantization parameters for the timings that the image signal processor processes frames f3, f4 are adjusted/increased to Q1+Δ. The Δ is a positive value. By this way, the temperatures for the timings that the image signal processor processes frames f3, f4 may be lower than the temperature threshold value.

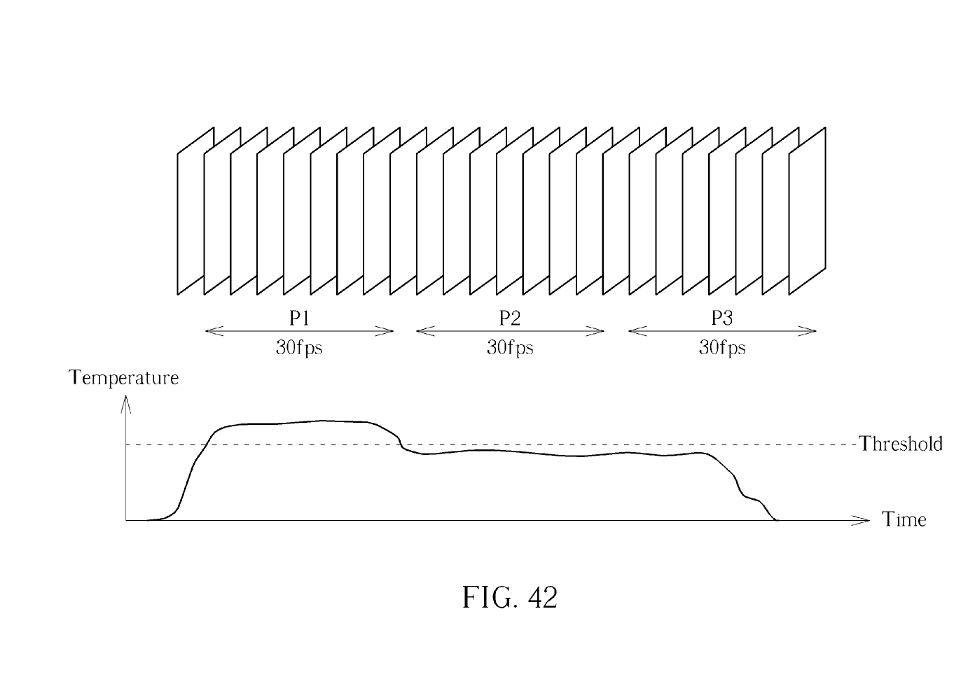

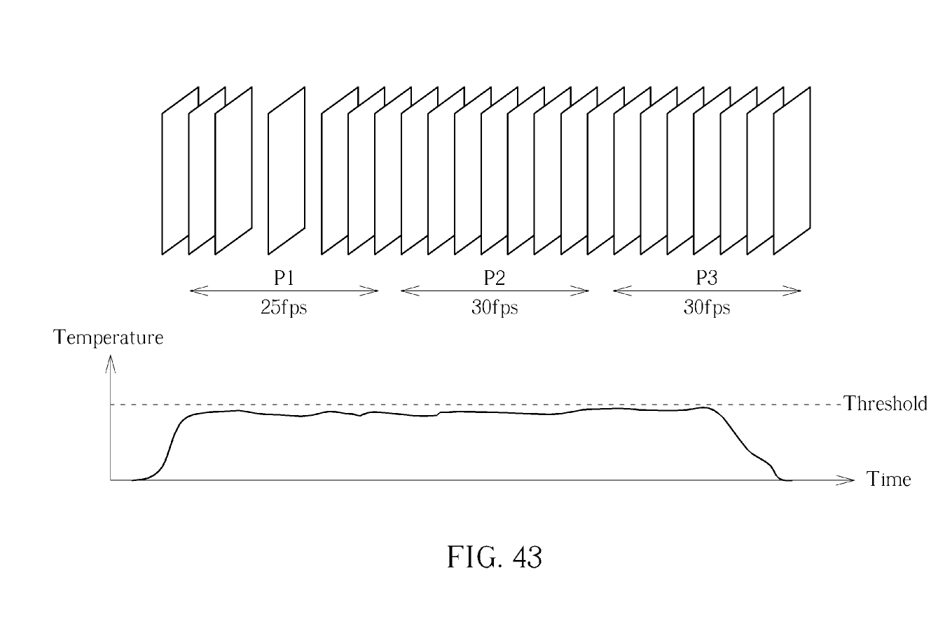

In the embodiments of FIG. 42 and FIG. 43, the device parameter includes a temperature, and the operating parameter includes a frame rate. In the embodiments of FIG. 42 and FIG. 43, the frame rate of the video encoder 409 in FIG. 27 is adjusted. However, the combination of the temperature and the frame rate can be applied to any other device(s) (e.g. the image signal processor) of the image/video processing module other than the image sensor.

Please refer to FIG. 42, the frame rates for the time periods P1, P2 and P3 are all 30 fps. For such case, the temperature for the time period P1 is over a temperature threshold value. Accordingly, in the embodiment of FIG. 43, the frame rate for the time period P1 is adjusted to 25 fps by, for example, dropping frames. By this way, the temperature for the time periods P1 may be lower than the temperature threshold value correspondingly.

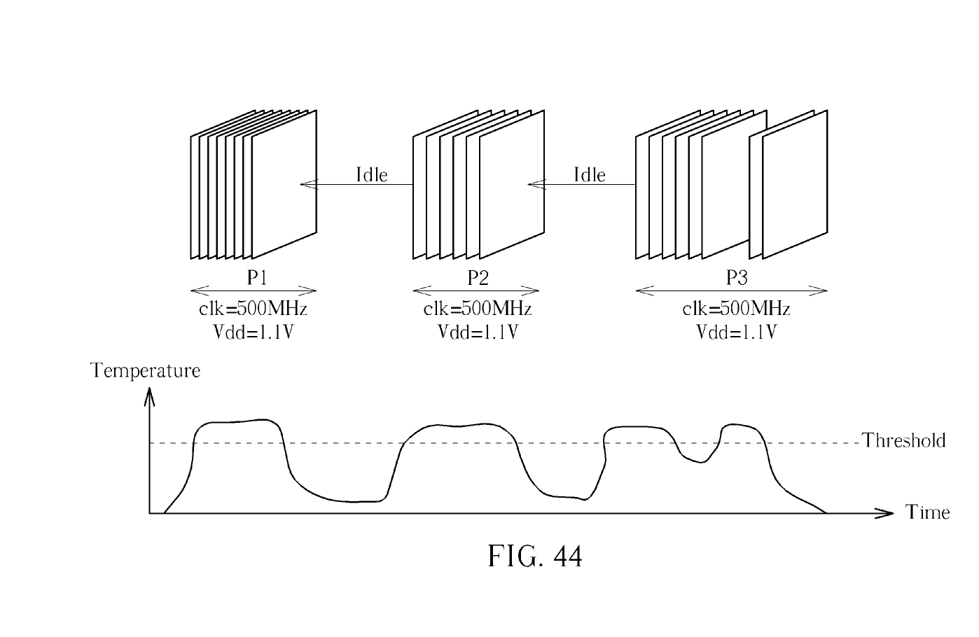

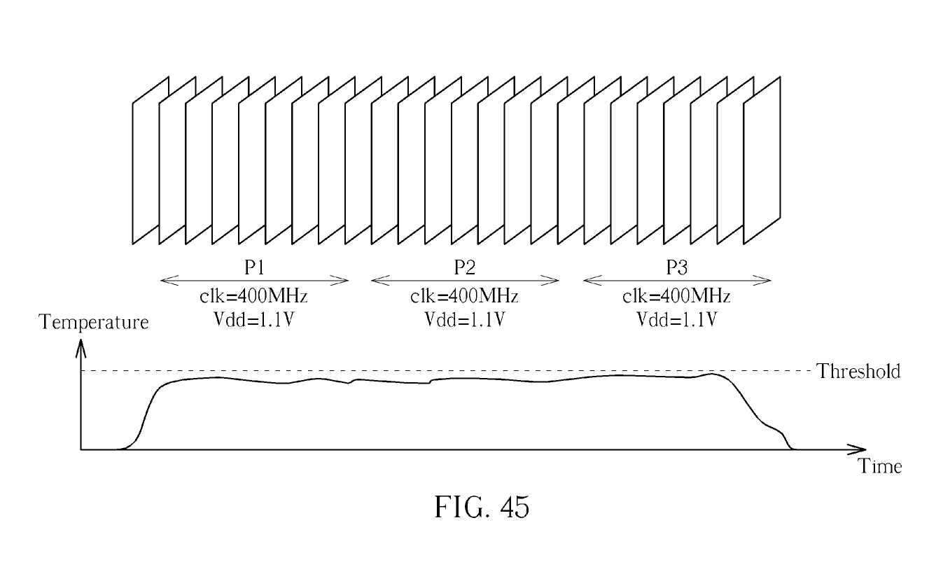

In the embodiments of FIG. 44 and FIG. 45, the device parameter includes a frame resolution or a frame rate, and the operating parameter includes an operating speed. In one embodiment, the operating speed is adjusted via adjusting a clock rate, but not limited. Further, in the embodiments of FIG. 44 and FIG. 45, the operating speed of the image signal processor 403 (clk) in FIG. 27 is adjusted. However, the combination of the frame resolution/frame rate and the operating speed can be applied to any other device(s) (e.g. encoder) of the image/video processing module other than the image signal processor. Further, in the embodiments of FIG. 44 and FIG. 45, the frame resolution is 4k and the frame rate is 60 fps.

Please refer to FIG. 44, the clock rates for the time periods P1, P2, P3 are all 500 MHz, and the temperatures for the time periods P1, P2, P3 are over a temperature threshold value. In the embodiment of FIG. 45, the clock rates for the time periods P1, P2, P3 are all adjusted to 400 MHz since the frame resolution or the frame rate is over a frame resolution threshold value or a frame rate threshold value. Thereby the temperatures for the time periods P1, P2, P3 may be lower correspondingly. Please note, in the embodiment of FIG. 45, the clock rates for the time periods P1, P2, P3 are all adjusted even if the corresponding temperature is lower than the temperature threshold value, since the adjusting of the clock rate may be based on the frame rate or the frame resolution.

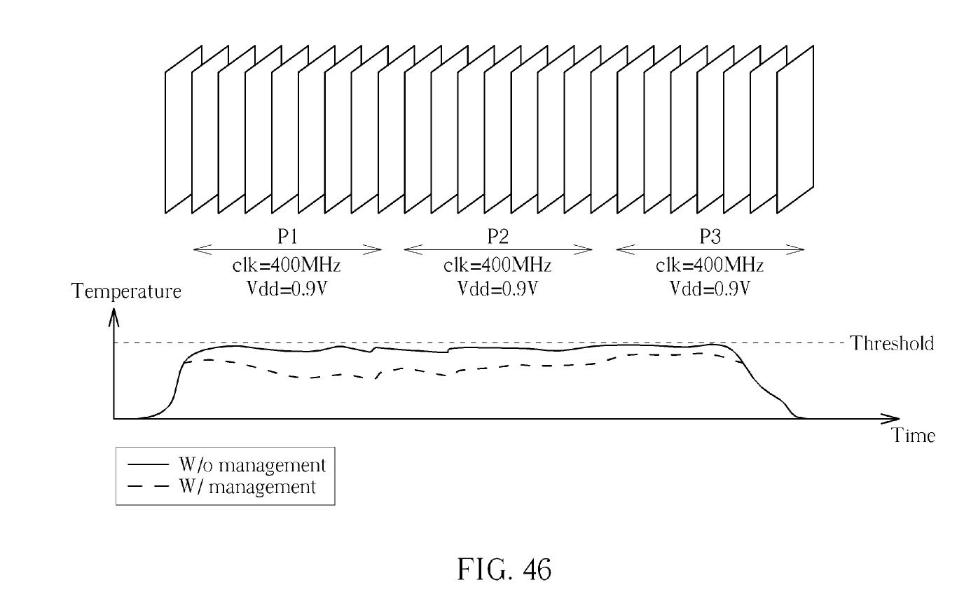

In one embodiment, the operating voltage is adjusted to further reduce the temperatures. Following the embodiment of FIG. 45, the embodiment of FIG. 46 further adjusts the operating voltage Vdd from 1.1v to 0.9v for each of the time periods P1, P2, and P3. Thereby the temperatures for the time periods P1, P2, and P3 can be further reduced. Please note the operation for adjusting the operating voltage Vdd is not limited to adjust the operating voltage under the situation depicted in FIG. 45. For example, the operating voltage Vdd for the embodiment depicted in FIG. 44 may be adjusted as well to reduce the temperatures.

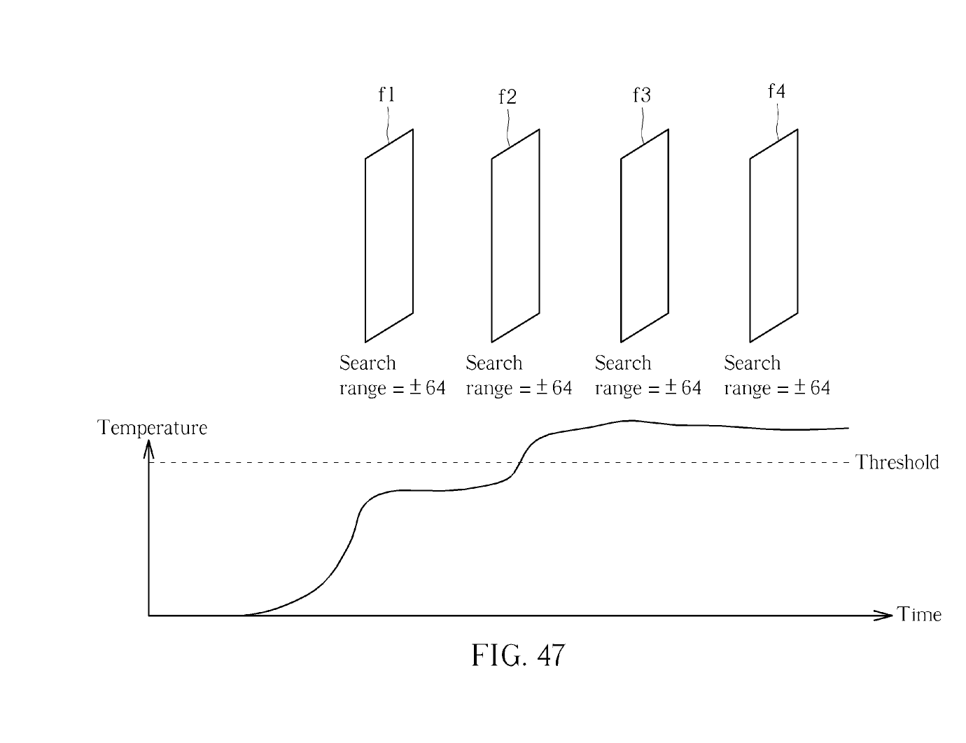

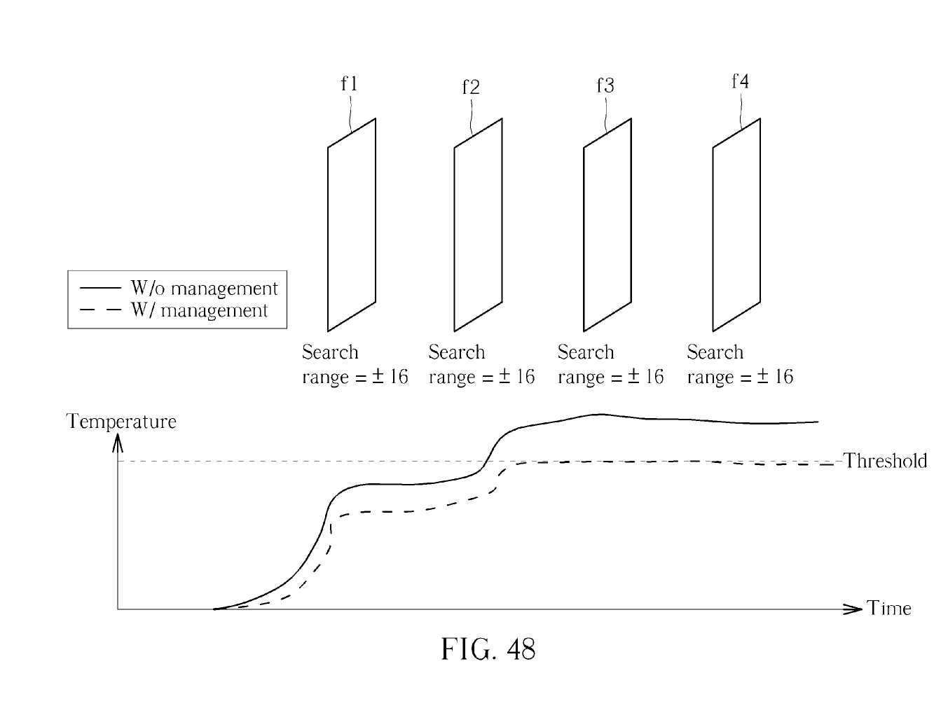

In the embodiments of FIG. 47 and FIG. 48, the device parameter includes a frame resolution or a frame rate, and the operating parameter includes a maximum motion search range (e.g. a motion searching window, but not limited). In the embodiments of FIG. 47 and FIG. 48, the maximum motion search range of the video encoder 409 in FIG. 27 is adjusted. However, the combination of the current and the maximum motion search range can be applied to any other device(s) of the image/video processing module other than the video encoder.

Please refer to FIG. 47, the maximum motion search ranges for the timings that the video encoder processes frames f1, f2, f3, f4 are all 64 pixels, and the temperatures for the timings that the video encoder processes frames f3, f4 are over a temperature threshold value. Accordingly, in the embodiment of FIG. 48, the maximum motion search ranges for all the timings that the image signal processor processes frames f1, f2, f3, f4 are adjusted to 16 pixels. By this way, the temperatures for the timings that the image signal processor processes frames f1, f2, f3, f4 may be lower than the current threshold value correspondingly.

Please note, in the embodiment of FIG. 48, the maximum motion search ranges for the timings that the image signal processor processes frames f1, f2 are also adjusted even if the corresponding temperature is lower than the temperature threshold value, since the adjusting of the maximum motion search ranges may be based on the frame rate or the frame resolution rather than the temperature.

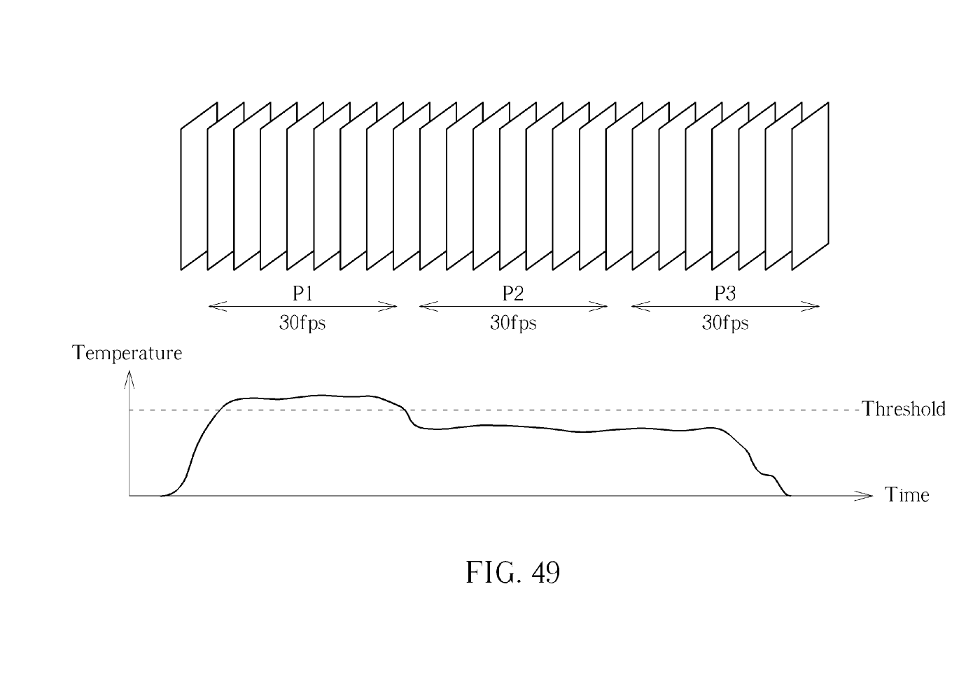

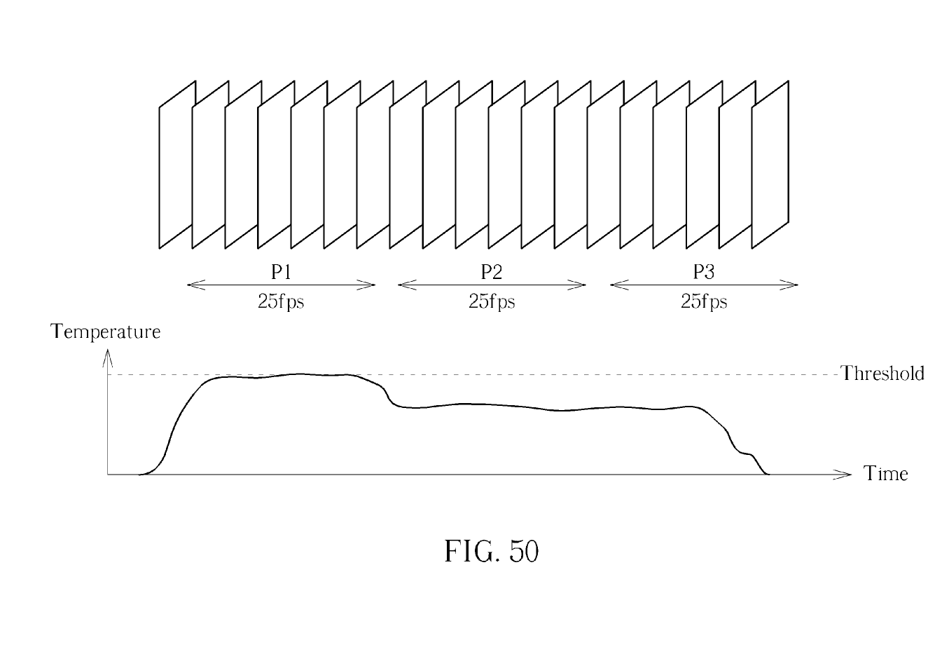

In the embodiments of FIG. 49 and FIG. 50, the device parameter includes a frame resolution or an ISO value, and the operating parameter includes a frame rate. In the embodiments of FIG. 49 and FIG. 50, the image/video processing module in FIG. 27 further comprises the video encoder, and the configuration of the frame rate of the video encoder is adjusted. However, the combination of the frame resolution/frame rate and the frame rate can be applied to any other device(s) of the image/video processing module other than the video encoder (e.g. the image signal processor). Also, in the embodiments of FIG. 49, FIG. 50, the frame resolution is 4000 and the ISO value is 1200.

Please refer to FIG. 49, the frame rates for the time periods P1, P2 and P3 are all 30 fps. For such case, the temperature for the time period P1 is over a temperature threshold value and the frame resolution or the ISO value is over a frame resolution threshold or an ISO value. Accordingly, in the embodiment of FIG. 50, the frame rates for the time period P1, P2, P3 are adjusted to 25 fps. By this way, the temperatures for the time periods P1, P2, P3 may be lower than the temperature threshold value correspondingly. Please note the frame rates for the time period P2, P3 are adjusted even if corresponding temperatures are lower than the temperature threshold value, since the frame rate may be adjusted based on the frame resolution or the ISO value rather than the temperature.

In view of above-mentioned embodiments, a thermal management method for controlling a temperature of an image/video processing module can be acquired. The method comprises: (a) acquiring at least one device parameter for at least one first device of the image/video processing module; and (b) adjusting at least one operating parameter for at least one second device of the image/video processing module according to the device parameter.

Based on above-mentioned embodiments, the temperature can be controlled via adjusting only a few devices, thus the performance for whole electronic apparatus would not greatly decrease.

Those skilled in the art will readily observe that numerous modifications and alterations of the device and method may be made while retaining the teachings of the invention. Accordingly, the above disclosure should be construed as limited only by the metes and bounds of the appended claims.

1. A thermal management method, comprising:
(a) acquiring at least one device parameter corresponding to at least one first device of an image/video processing module for an image capturing device or a video recording device; and
(b) adjusting at least one operating parameter for at least one second device of the image/video processing module according to the device parameter to control a temperature of the image/video processing module.

2. The thermal management method of claim 1, wherein the device parameter is generated by at least one operation performed by the first device.

3. The thermal management method of claim 1, wherein the device parameter is a configuration parameter of the first device.

4. The thermal management method of claim 1, further comprising:
determining at least one temperature for the first device of the image/video processing module according to the device parameter;
wherein the step (b) adjusts the operating parameter according to the determined temperature.

5. The thermal management method of claim 4, further comprising:
measuring an environment temperature; and
adjusting the determined temperature for the first device of the image/video processing module based on the environment temperature to generate an adjusted temperature;
wherein the step (b) adjusts the operating parameter according to the adjusted temperature.

6. The thermal management method of claim 1,
wherein the image/video processing module comprises at least one of following devices: an image sensor, an image signal processor, an image encoder, a video encoder and a memory device.

7. The thermal management method of claim 1, wherein the device parameter comprises at least one of: a temperature, a current value, a signal delay value, a frame resolution, a frame rate, an ISO value, a focus level, an exposure level, a quantization parameter, a coding tool, a maximum motion search range, and a power consumption value.

8. The thermal management method of claim 1, wherein the operating parameter comprises at least one of: an operating speed, an ISO value, a frame resolution, a frame rate, an operating voltage, a maximum motion search range, and a quantization parameter.

9. The thermal management method of claim 1, wherein the device parameter comprises a current value, and the operating parameter comprises an operating speed, an operating voltage, a frame resolution or an ISO value, a quantization parameter or a maximum motion search range.

10. The thermal management method of claim 1, wherein the device parameter comprises a frame resolution or a frame rate, and the operating parameter comprises an operating speed, an ISO value, an operating voltage, a frame rate or a maximum motion search range.

11. The thermal management method of claim 1, wherein the device parameter comprises an ISO value, and the operating parameter comprises a frame rate.

12. An electronic system with a thermal control mechanism, comprising:
an image/video processing module, configured to processing image data or video data;
a parameter acquiring device, configured to acquire at least one device parameter corresponding to at least one first device of the image/video processing module; and
a thermal management device, configured to adjust at least one operating parameter for at least second device of the image/video processing module according to the device parameter.

13. The electronic system of claim 12, wherein the device parameter is generated by at least one operation performed by the first device.

14. The electronic system of claim 12, wherein the device parameter is a configuration parameter of the first device.

15. The electronic system of claim 12, wherein the thermal management device further determines at least one temperature for the first device of the image/video processing module, and adjusts the operating parameter according to the determined temperature.

16. The electronic system of claim 15, wherein the thermal management device further measures an environment temperature, and adjusts the determined temperature for the first device of the image/video processing module based on the environment temperature to generate an adjusted temperature; wherein the thermal management device adjusts the operating parameter according to the adjusted temperature.

17. The electronic system of claim 12,
wherein the image/video processing module comprises at least one of following devices: an image sensor, an image signal processor, an image encoder, a video encoder and a memory device.

18. The electronic system of claim 12, wherein the device parameter comprises at least one of: a temperature, a current value, a signal delay value, a frame resolution, a frame rate, an ISO value, a focus level, an exposure level, a quantization parameter, a coding tool, a maximum motion search range, and a power consumption value.

19. The electronic system of claim 12, wherein the operating parameter comprises at least one of: an operating speed, an ISO value, a frame resolution, a frame rate, an operating voltage, a maximum motion search range, and a quantization parameter.

20. The electronic system of claim 12, wherein the device parameter is a current value, and the operating parameter is an operating speed, an operating voltage, a frame resolution or an ISO value, a quantization parameter or a maximum motion search range.

21. The electronic system of claim 12, wherein the device parameter comprises a frame resolution or a frame rate, and the operating parameter comprises an operating speed, an ISO value, an operating voltage, a frame rate or a maximum motion search range.

22. The electronic system of claim 12, wherein the device parameter comprises an ISO value, and the operating parameter comprises a frame rate.
